(19) United States
(12) Patent Application Publication
(10) Pub. No.: US 2013/0089635 A1
(43) Pub. Date: Apr. 11, 2013

(54) SYSTEM AND METHOD FOR FEEDING RUMINANTS BASED ON RUMEN MORPHOLOGY

(71) Applicant: LAND O'LAKES PURINA FEED LLC, Shoreview, MN (US)

(72) Inventors: Jill A. Davidson, Washington, MO (US); Dari Brown, Lake Saint Louis, MO (US); Bill L. Miller, Labadie, MO (US)

(73) Assignee: LAND O'LAKES PURINA FEED LLC, Shoreview, MN (US)

(21) Appl. No.: 13/645,960

(22) Filed: Oct. 5, 2012

Related U.S. Application Data
(60) Provisional application No. 61/544,073, filed on Oct. 6, 2011.

(51) Int. Cl. A23K 1/18

(52) U.S. Cl. CPC A23K 1/1813
USPC 426/2; 426/635

(57) ABSTRACT

Rumen performance and ruminant growth in growing ruminants is studied through rumen morphological studies and growing ruminant developmental studies. Based on the studies, a feed composition containing an effective amount of milk replacer, supplemental feed or both is administered to the ruminant over a growing period to optimize rumen growth. A method of formulating a feed formulation for a ruminant involves studying at least rumen morphology of one ruminant ingesting a diet with an amount of milk replacer, supplemental feed or both, and formulating the feed ration for another ruminant based on the study. A feed composition formulated based on rumen morphological studies includes an effective amount of nutrients to optimize rumen growth in the growing ruminants characterized by one or more of optimized rumen size, rumen papillae density, rumen papillae surface area, rumen papillae histology in the ruminant by twenty-four weeks of age.

### FIELD OF THE INVENTION

Implementations provide feeding methods, feed formulation methods and feed compositions for growing ruminants, each of which may be based on rumen morphological and ruminant developmental studies in growing ruminants.

### BACKGROUND

Calves through about the first twelve weeks of life are fed a monitored diet of milk and grain to support the growth and rumen development of the calf. From about twelve weeks to about twenty-four weeks of age, calf development generally goes unmonitored and calves are fed high amounts of hay and other forage with limited grain. However, the calf diet during the first twenty-four weeks of life influences the calf's growth and rumen development throughout life. Stunted growth, improper rumen development or both in the growing calf may be detrimental to the longevity of heifers that are in a critical stage of growth until reaching puberty.

### SUMMARY

Provided herein are systems and methods for improving rumen performance based on rumen morphological studies conducted on calves fed monitored diets up to the first twenty-four weeks of age. Data on rumen morphology and ruminant growth in growing ruminants is used to formulate feeding methods and feed compositions for growing ruminants. The feed formulations and methods prepare the rumen for development, control rumen development and increase ruminant growth in growing ruminants beginning from birth and extending to about twenty-four weeks of age. Ingested milk replacer and starter feed during the first twelve weeks of life may prepare the rumen for optimal development during later development stages, particularly, from twelve to twenty-four weeks of age. Ingested feed provided at a controlled nutrient level and rate may optimize papillae growth within the rumen of the growing ruminant for proper nutrient absorption from twelve to twenty-four weeks of age. The growing ruminant receiving the feeding compositions provided herein may exhibit increased weight gain, frame growth (e.g., height and length) and feed intake. Moreover, optimized rumen growth in the growing ruminant may increase longevity and improve performance (e.g., earlier breeding age, increased weight gain, milk production, feed efficiency, multiple lactations) of the mature ruminant after the growing period.

In certain implementations, a method for improving rumen performance in growing ruminants is based on rumen morphological studies and involves orally administering to the growing ruminant a feed composition containing an effective amount of one or more of milk replacer and supplemental feed over a growing period of the growing ruminant to optimize rumen growth, wherein the feed composition is formulated based on the studies.

In further implementations, a method of formulating a feed formulation for a first ruminant involves studying rumen morphology of at least a second ruminant ingesting a first diet with an amount of one or more of calf milk replacer and supplemental feed; and formulating the feed ration of one or more of calf milk replacer and supplemental feed for the first ruminant based on the rumen morphology studies of the second ruminant.

In still further implementations, a feed formulation for growing ruminants includes an effective amount of at least one of milk replacer and supplemental feed to optimize rumen growth in the growing ruminants, the optimized rumen growth characterized by one or more of optimized rumen size, rumen papillae density, rumen papillae surface area and rumen papillae histology in the ruminant by twenty-four weeks of age, wherein the formulation is based on rumen morphological studies in growing ruminants.

### DESCRIPTION OF THE DRAWINGS

FIG. 1 is a graph depicting differences in body weight in growing calves that are fed 4 pounds of supplemental feed versus growing calves fed 10 pounds of supplemental feed over a twelve-week period beginning at twelve weeks of age.

FIG. 2 is a graph depicting differences in hip height in growing calves that are fed 4 pounds of supplemental feed versus growing calves fed 10 pounds of supplemental feed over a twelve-week period beginning at twelve weeks of age.

FIG. 3 is a graph depicting differences in body length in growing calves that are fed 4 pounds of supplemental feed versus growing calves fed 10 pounds of supplemental feed over a twelve-week period beginning at twelve weeks of age.

FIG. 4 is a graph depicting differences in feed to gain ratio in growing calves that are fed 4 pounds of supplemental feed versus growing calves fed 10 pounds of supplemental feed over a ten week period beginning at twelve weeks of age.

FIG. 5 illustrates rumens and papillae samples from the cranial dorsal portion of the rumen from two sacrificial bull calves each at twenty-four weeks of age where the growing calves were fed either 4 pounds of supplemental feed or 10 pounds of supplemental feed over a twelve-week period.

FIG. 6 illustrates the various sections of the rumen of a growing calf.

FIG. 7A is a graph depicting differences in total dry matter intake in growing calves that are fed supplemental feed at a rate of 4 pounds per day, 8 pounds per day, 10 pounds per day, 12 pounds per day and ad libitum over an eight week period beginning at twelve weeks of age.

FIG. 7B is a graph depicting differences in hay intake in growing calves that are fed supplemental feed at a rate of 4 pounds per day, 8 pounds per day, 10 pounds per day, 12 pounds per day and ad libitum over an eight week period beginning at twelve weeks of age.

FIG. 8 is a graph depicting differences in body weight in growing calves that are fed 4 pounds of supplemental feed, 10 pounds of supplemental feed and ad libitum supplemental feed over a twelve-week period beginning at twelve weeks of age, according to certain implementations.

FIG. 9 is a graph depicting differences in hip height in growing calves that are fed 4 pounds of supplemental feed, 10 pounds of supplemental feed and ad libitum supplemental feed over a twelve-week period beginning at twelve weeks of age, according to certain implementations.

FIG. 10 is a graph depicting differences in body length in growing calves that are fed 4 pounds of supplemental feed, 10 pounds of supplemental feed and ad libitum supplemental feed over a twelve-week period beginning at twelve weeks of age, according to certain implementations.

FIGS. 11A-11D illustrate ruminal cranial dorsal papillae from four sacrificial bull calves each at twenty weeks of age where the growing calves were fed either 4 pounds, 8 pounds, 10 pounds or ad libitum amounts of supplemental feed over an eight week period, according to certain implementations.

FIGS. 12A-12C illustrate ruminal cranial ventral papillae from three sacrificial bull calves each at twenty-four weeks of age where the growing calves were fed either 4 pounds, 10 pounds or ad libitum amounts of supplemental feed over a twelve week period, according to certain implementations.

FIGS. 13A-13C illustrate ruminal cranial dorsal papillae from three sacrificial bull calves each at twenty-four weeks of age where the growing calves were fed either 4 pounds, 10 pounds or ad libitum amounts of supplemental feed over a twelve week period, according to certain implementations.

FIGS. 14A-14C illustrate ruminal caudal ventral papillae from three sacrificial bull calves each at twenty-four weeks of age where the growing calves were fed either 4 pounds, 10 pounds or ad libitum amounts of supplemental feed over a twelve week period, according to certain implementations.

FIGS. 15A-15C illustrate ruminal caudal dorsal papillae from three sacrificial bull calves each at twenty-four weeks of age where the growing calves were fed either 4 pounds, 10 pounds or ad libitum amounts of supplemental feed over a twelve week period, according to certain implementations.

FIG. 16 illustrates a magnified view of rumen papillae at 24 weeks of age.

FIG. 17 is a graph depicting differences in initial and final body weight in growing calves that are fed 3-4 pounds of commercial feed versus growing calves fed 10 pounds from approximately twelve to twenty-four weeks of age.

FIG. 18 is a graph depicting differences in initial and final hip height in growing calves that are fed 3-4 pounds of commercial feed versus growing calves fed 10 pounds from approximately twelve to twenty-four weeks of age.

FIG. 19 is a graph depicting differences in average daily gain in growing calves that are fed 3-4 pounds of commercial feed versus growing calves fed 10 pounds from approximately twelve to twenty-four weeks of age.

FIG. 20 is a graph depicting differences in body weight in growing calves that are fed three different amounts of protein in milk replacers from zero to seven weeks of age and supplemental feed over a twelve-week period beginning at birth.

FIG. 21 is a graph depicting differences in hip height in growing calves that are fed three different amounts of protein in milk replacers from zero to seven weeks of age and supplemental feed over a twelve-week period beginning at birth.

FIG. 22 is a graph depicting differences in body length in growing calves that are fed three different amounts of protein in milk replacers from zero to seven weeks of age and supplemental feed over a twelve-week period beginning at birth.

FIG. 23 is a graph depicting differences in body volume in growing calves that that are fed three different amounts of protein in milk replacers from zero to seven weeks of age and supplemental feed over a twelve-week period beginning at birth.

FIGS. 24A-24C illustrate ruminal cranial ventral papillae from three sacrificial bull calves each at four weeks of age where the growing calves were fed three different amounts of protein in milk replacers and supplemental feed.

FIGS. 25A-25C illustrate ruminal cranial ventral papillae from three sacrificial bull calves each at eight weeks of age where the growing calves were fed three different amounts of protein in milk replacers and supplemental feed, according to certain implementations.

FIGS. 26A-26C illustrate ruminal cranial dorsal papillae from three sacrificial bull calves each at twelve weeks of age where the growing calves were fed three different amounts of protein in milk replacers and supplemental feed.

FIGS. 27A-27C illustrate ruminal cranial ventral papillae from three sacrificial bull calves each at twelve weeks of age where the growing calves were fed three different amounts of protein in milk replacers from zero to seven weeks of age and supplemental feed.

FIG. 28 is a chart illustrating the total color difference of rumens from across the three treatment groups at four, eight and twelve weeks of age, respectively, relative to the lightest color rumen.

FIG. 29 is a chart illustrating light or dark color evaluation the three treatment groups across the three treatment groups at four, eight and twelve weeks of age, respectively.

### DETAILED DESCRIPTION

Implementations provide for feeding compositions and methods for growing ruminants based on information related to rumen morphology and rumen growth in growing ruminants. By ingesting the feed compositions formulated based on rumen morphological and ruminant growth studies, as provided herein, the growing ruminant may experience increased performance during the growing period and after reaching puberty, which may thereby increase longevity of heifers over multiple lactations.

It has been found that the ingestion of milk replacers along with starter feeds (e.g., supplemental feed), one or both of which include required nutrients, influences ruminal development by, for example, preparing the rumen for fermentation of dry matter and facilitating the development of rumen papillae. The increased nutrients have been found to not negatively impact rumen morphology and rumen papillae, and to improve growth of the young animal. Further, it has been found that the ingestion of grains in the growing ruminant significantly influences ruminal development, and implementations include grains or a mixture of grains provided at an enhanced rate along with forage in the growing ruminant diet.

As is known, the digestive tract of a growing ruminant includes a stomach that has four sections: a rumen, a reticulum, an omasum, and an abomasum. The rumen is separated into four sections: the cranial ventral, cranial dorsal, caudal ventral and caudal dorsal section. The rumen and reticulum may be referred to as the reticulo-rumen. Generally, the reticulo-rumen functions in the fermentation of ingested feed and includes papillae that absorb nutrients, the omasum absorbs water and minerals, and the abomasum functions in acid hydrolysis and enzymatic digestion. Rumen development may be influenced by several factors including substrates introduced therein (e.g., grains and forage), liquid (e.g., milk replacers, water and saliva), the establishment of bacteria within the rumen, the absorptive ability of the papillae and other tissue, and the outflow of material from the rumen through muscular action.

The rumen of growing ruminants establishes a population of ruminal microbes, which digest carbohydrates for volatile fatty acid (“VFA”) production. VFA production is a key indicator of adequate rumen functioning. Grains provide the necessary carbohydrates that are digested by ruminal microbes for VFA production in the rumen, particularly butyrate. It is believed that papillae growth is stimulated by the production of butyrate or butyric acid. At about twelve weeks of age, the growing ruminant begins to ingest hay along with grains. Hay causes the musculature of the rumen wall to increase, which is necessary for the development of the rumen, but ingestion of hay stimulates the production of more acetic acid than butyric acid, thus limiting the growth of papillae. Thus, while both grains and hay stimulate VFA production, and both are necessary for ruminal development, it has been found that a diet with an excessive amount of hay will not provide adequate concentrations of butyrate to stimulate papillae growth for the growing ruminant. Immature papillae may result in decreased performance of the mature ruminant due to decreased absorptive capacities of the papillae.

Papillae growth in the rumen is critical in the development of the rumen of growing ruminants because papillae are responsible for absorbing nutrients. However, transfer of nutrients to the blood supply of papillae tissue may vary by the absorptive capacity of the papillae which is based on papillae development during this growing period. Specifically, the papillae absorb nutrients at a higher rate transferring them to the blood supply. When papillae growth is stunted in the growing ruminant, such as by not receiving a diet with adequate grains and carbohydrates, the efficiency of nutrient absorption within the rumen is reduced. When excessive amounts of grains and carbohydrates are fed, the pH of the rumen environment may drop. This more acidic condition may cause the growing ruminant to experience parakeratosis or hyperkeratosis where the rumen papillae may harden causing their absorptive capacity to decrease. Abscesses in the rumen wall may also be caused by the lower rumen pH. This insult to the rumen wall may reduce the productive life of ruminants.

By studying the rumen and growth of the ruminant of sacrificial bull calves fed varying amounts of grain and hay, it has been found that an effective amount of grain may be fed to the calf during a growing period, e.g., beginning at about twelve weeks of age and lasting for about twelve weeks to about twenty-four weeks of age, which optimizes papillae growth in the rumen. It is noted that no other method of understanding rumen development and health is known from euthanizing steers aside from the use of rumen cannulated animals, and surgery implications and number of animals needed to assess rumen parameters reduce the merit of this latter approach.

The growing ruminant ingesting the milk replacer, supplemental feed, or both, during a growing period, where such diets are formulated based on rumen morphological studies and developmental studies provided herein, may achieve an optimally developed rumen, optimally developed rumen papillae surface area and histology such as keratin formation and thickness of muscle and sub-mucosal layers, a relatively larger frame, increased weight, improved energy efficiency, a stronger immune system as well as other aspects of increased performance. For example, when ruminants are fed milk replacers and supplemental feed with increased nutrient levels during a first portion of the growing period, the animal's exhibit improved growth while not negatively affecting rumens, including papillae. Upon reaching the end of the first portion of the growing period, the calves may be prepared for optimized rumen development during a second portion of the growing period following the first. When ruminants are fed supplemental dry feed at an enhanced rate during a second portion of the growing period, it is believed that the improvements to the herd may result due to a more developed rumen as well as an increase surface area of the rumen papillae tissue that more efficiently absorbs nutrients, thereby increasing performance using an efficient and safe feeding program. Optimized rumen and papillae growth in the growing ruminant may increase longevity and improve performance of the mature ruminant after the growing period (e.g., earlier breeding age, increased weight gain, milk production, feed efficiency, and multiple lactations). A well-developed and fully functioning rumen will help growing ruminants (e.g., heifers and bulls) better utilize forage-based diets which may lead to a more productive mature ruminant.

In some implementations, calf milk replacer and supplemental feed in the form of starter feed may be formulated based on rumen morphological and growing ruminant developmental studies and may be fed to the young animal during the first portion of the growing period. The liquid compositions may include increased nutrient levels compared to prior approaches through increasing nutrients (e.g., protein and fat), enhancing feeding rates, or both. The increased nutrient level is increased over feeding traditional milk replacers typically formed of 20 percent protein and 20 percent fat.

The dry feed compositions such as supplemental feed in the form of starter feed may be fed during this first portion and include an increased level of protein and be fed to the growing ruminant. The liquid feeds may be fed to the young animal during, for example, the first eight weeks of life, and the dry feeds may be offered from birth to about twelve weeks of age or more. The liquid and dry feeds may be provided in combination during a weaning period, such as from about six to about eight weeks of age or another weaning period common to young animals.

Liquid feeds may be provided at an enhanced rate, such as about 1.4 to 2.5 pounds per day, and preferably at about 1.8 pounds per day during about the first week of life or during a first week of treatment and at 2.5 pounds per day during weeks two through 2; may include a protein concentration of between about 22 to 30 percent, or preferably at least about 24 percent, or more preferably at about 28 percent; may include a fat composition of between about 18 and 22 percent, and preferably at about 20 percent; and combinations and variations thereof.

Dry feed compositions may be formed of a combination of grains, fiber and protein to provide nutrients to the young animal, and may include a protein concentration of about 22 to about 30 percent, and preferably at least about 23 percent, or more preferably at about 25 percent on a dry basis. The dry feed may be fed ad libitum during the first portion of the growing period. However, young animals prefer nutrients in the form of milk and begin consuming dry feeds around four weeks of age. As the calf grows from about weeks four to twelve of age, the consumption of dry feeds will increase to meet the nutrient demands of the animal. This consumption of dry feeds will promote papillae development and early stages of developing the ruminant through microbial fermentation in rumen and rumination (e.g., chewing).

In further implementations, a supplemental feed ration may be formulated based on the rumen morphological and growing ruminant developmental studies and may be fed to the growing ruminant during the second portion of a growing period after the first portion. The supplemental feed may be provided at an enhanced rate of between about 8 pounds to about 12 pounds, between about 8 pounds and 10 pounds or between about 10 pounds and 12 pounds per day per growing ruminant, or about 8 pounds, about 10 pounds or about 12 pounds per day per growing ruminant, which is an enhanced rate over prior approaches in which about 4 pounds per day is fed to a young ruminant. In addition, by providing the growing ruminant with the enhanced rate of supplemental feed per day during the second portion of the growing period, such as beginning at about twelve weeks of age, the ruminant may be ingesting essentially ad libitum amounts of supplemental feed due to the size of their rumen (e.g., the enhanced amount of supplemental feed may be substantially equal to the volume of the rumen), but as the growing ruminant matures over the course of twelve weeks to twenty-four weeks of age, the rumen grows and is conditioned by the enhanced feeding rate of supplemental feed along with more hay to efficiently digest harvested forages as the ruminant reaches maturity.

The supplemental feed may include grains (e.g., corn, wheat, soybean meal, oats, rice, barley, milo) and fiber and may be a complete feed (e.g., a complete palate), a texturized feed (e.g., including the complete palate, whole grains and molasses) and so on. The supplemental feed provides a level of protein and energy required for the growing ruminant. Implementations may also provide a balanced feeding ration of grains, which may be in the form of a supplemental feed, combined with forage such as hay. In some implementations, additives may be included in the supplemental feed or in the feed formulation with the supplemental feed. In some implementations, the supplemental feed may include an effective amount of grain at a rate from about 5.0 lbs. to about 5.5, 6.0, 6.5, 7.0, 7.5, 8.0, 8.5, 9.0, 9.5, 10.0 or 10.5 lbs. per day, from about 6 lbs. to about 6.5, 7.0, 7.5, 8.0, 8.5, 9.0, 9.5, 10.0 or 10.5 lbs. per day, or at about 5.0, 5.5, 6.0, 6.5, 7.0, 7.5, 8.0, 8.5, 9.0, 9.5, 10.0 or 10.5 lbs. per day. In some implementations, the supplemental feed may include an effective amount of grain that provides a level of starch from about 20 percent to about 25, 30, 35 or 40 percent, from about 30 percent to about 35 or 40 percent, or at about 20, 25, 30, 35, or 40 percent.

A growing ruminant may be a calf, a heifer calf, or a bull calf. When fed during a first portion of the growing phase, the ruminant may be a newborn or a few days old, may be 65 pounds to about 100 pounds. When fed during the second portion of the growing phase, the ruminant may be recently weaned such as about 4 weeks post-weaning, about 200 pounds to about 300 pounds, beginning from about 200 pounds to about 300 pounds, that is from about 300 pounds to about 500 pounds, or that has not yet reached puberty, or combinations thereof (e.g., a heifer calf that is about twelve weeks of age and about 200 to about 300 pounds).

As provided herein, a growing period for the growing ruminant may extend six months from the time of the ruminant's birth, from birth to about twelve weeks of age, from birth to about twenty-four weeks of age, from about twelve weeks to about twenty-two weeks of age (e.g., after birth), from about twelve weeks to about twenty-four weeks of age.

A first portion of a growing period may extend up to twelve weeks of age, up to about four weeks after weaning, from about two to about six weeks after weaning; may begin at or just after birth; and may end at about twelve weeks of age, or when the animal ingests a sufficient amount of starter feed (e.g., supplemental feed). In some implementations, weaning should occur when 1.5 pounds of starter feed is consumed for three consecutive days. Starter feeding may continue for approximately four weeks after weaning.

A second portion of the growing period may be from about twelve to about twenty-four weeks of age. The growing period, or portions thereof, may begin at or about birth, at or about twelve weeks of age, when the ruminant is at or about 200 pounds or 300 pounds. The growing period, or portions thereof, may end when the ruminant is at or about twelve or twenty-four weeks of age, is at or about 500 pounds, or when the ruminant reaches puberty, or combinations thereof (e.g., a heifer calf ranging from about twelve weeks of age to twenty-four weeks of age or up to 500 pounds). While the ruminant continues to grow after the growing period, e.g., to a mature weight of about 1200 to about 1400 pounds, certain implementations provide supplemental feeds at least during growing periods as provided above.

The implementations may be based on the following examples, which are for illustrative purposes, and those skilled in the art will appreciate that various modifications are within the scope of the invention.

### Example 1

This example demonstrates a twelve-week study period in which a group of 64 calves beginning at about twelve weeks of age were orally administered feed compositions with differing amounts of supplemental feed. The calves performed differently and exhibited differences in ruminant development (e.g., frame growth and weight) and rumen morphology after ingesting the feed over the course of twelve weeks.

Prior to the study, all calves received 28:20 calf milk replacer (28 percent protein and 20 percent fat) until six weeks of age, as well as AMPLI-Calf® 22% textured starter from day 3 to twelve weeks of age.

Twelve-week-old calves that were both co-mingled calves and shipped calves (purchased from several Wisconsin sale barns from multiple sources and grouped from these sources and shipped to northwestern Iowa on a given day) were randomly separated into 16 pens, and 32 of the calves were provided 4 pounds of supplemental feed per calf per day, while the other 32 calves were provided 10 pounds of the supplemental feed per calf per day.

The study group was fed either TCR (pelleted diet, e.g., not grain visible) or textured feed (mixer pellet with whole corn, oats, and molasses) each having similar nutritional profiles. The composition of the supplemental feeds used in this example is shown in Table 1A.

TABLE 1A
Supplemental feed composition

| | Texturized Feed | TCR |
|---|---|---|
| Components | (Wt. %) Dry Basis) | (Wt. % Dry Basis) |
| Corn, Dry shell ground | 35.0 | 18.9 |
| SUPRCOAT68-5 CRS | 2.0 | |
| Wheat Red Dog | 0 | 9.0 |
| Soybean Meal 48% | 20.7 | 16.4 |
| Wheat Midds | 7.5 | 19.0 |
| Cottonseed Hulls | 6.0 | 6.5 |
| Soybean Hulls | 4.8 | 19.1 |
| Alfalfa Meal 17% | 2.5 | 2.5 |
| SurePro | 2.2 | 2.2 |
| Calcium Carbonate | 1.6 | 1.5 |
| Molasses, Liquid | 0.7 | 2.7 |
| Other minor ingredients | 2.1 | 2.1 |

The calves had access to hay (e.g., mixed alfalfa hay, 16% CP) ad libitum during the twelve-week study period.

Table 1B includes a summary of particular nutrients present in the supplemental feed.

TABLE 1B

| | Texturized Feed | TCR |
|---|---|---|
| Nutrient | (Wt. % Dry Basis) | (Wt. % Dry Basis) |
| Crude Protein | 20.2 | 20.3 |
| Acid detergent soluble | 13.6 | 20.2 |
| fiber (ADF) | | |
| Neutral detergent soluble | 22.7 | 32.6 |
| fiber (NDF) | | |
| Starch | 33.9 | 21.6 |
| Fat | 3.0 | 3.1 |
| Calcium | 1.0 | 1.0 |
| Phosphorous | 0.5 | 0.6 |

Calf performance was observed every two weeks over the study period, and generally, calves fed 10 pounds of supplemental feed per day exhibited increased performance throughout the study period compared to calves fed 4 pounds of supplemental feed per day.

Statistical analysis was completed for body weight, hip height, body length, feed to gain ratio, total dry matter intake, hay intake, average daily gain, and papillae surface area and other papillae morphology. A P value of 0.10 means that 10 times out of 100 the results can be explained by factors other than the feeding of tested feed versus the lack of the tested feed. Likewise, a P value of 0.75 means that 75 times out of 100, the difference in value between the control group and the test group may be explained by factors other than the feeding of the increased rate(s) of supplemental feed versus the lower rate of feeding of the supplemental feed (e.g., 4 pounds per head per day). For purposes of comparing data in this document, P values of 0.10, or lower, are considered statistically significant. Thus, where a P value of 0.10 or less is returned for particular results, it is assumed that the differing results are fully explained by the test regimen, i.e.: the feeding of the increased rate(s) of supplemental feed versus the lower rate of feeding of the supplemental feed (e.g., 4 pounds per head per day).

Growing Ruminant Developmental Studies:

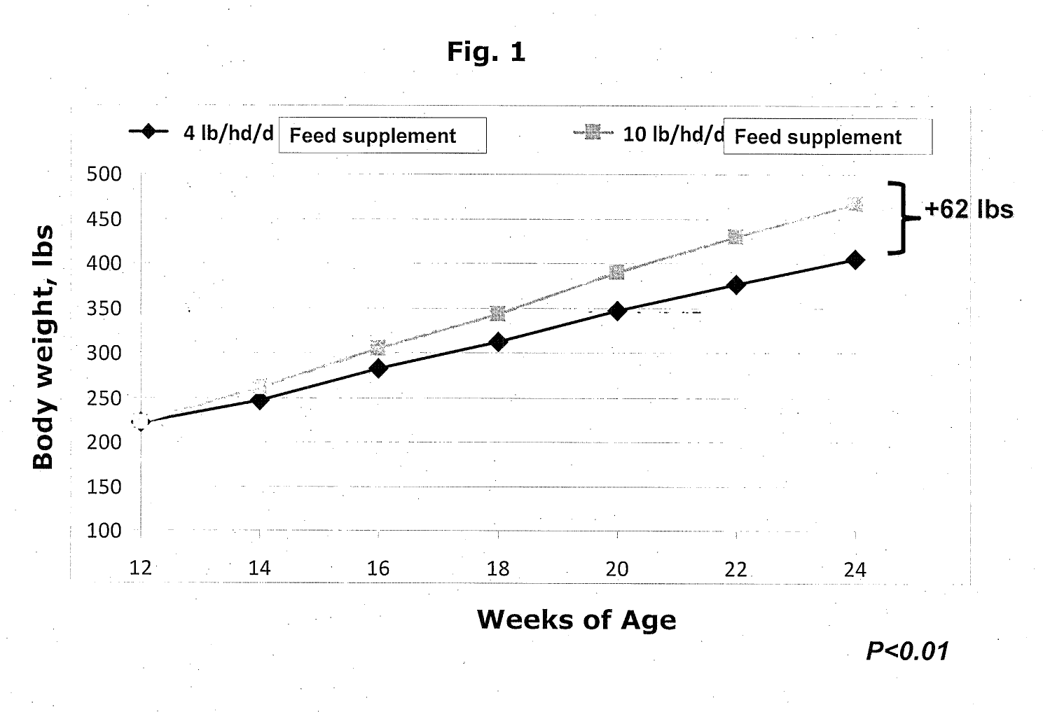

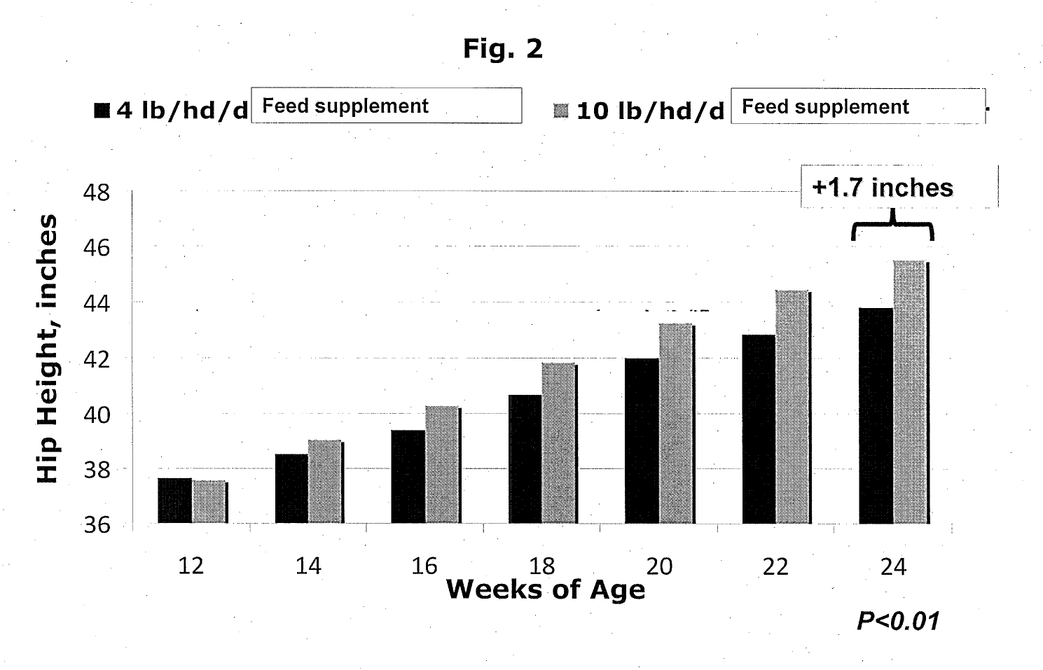

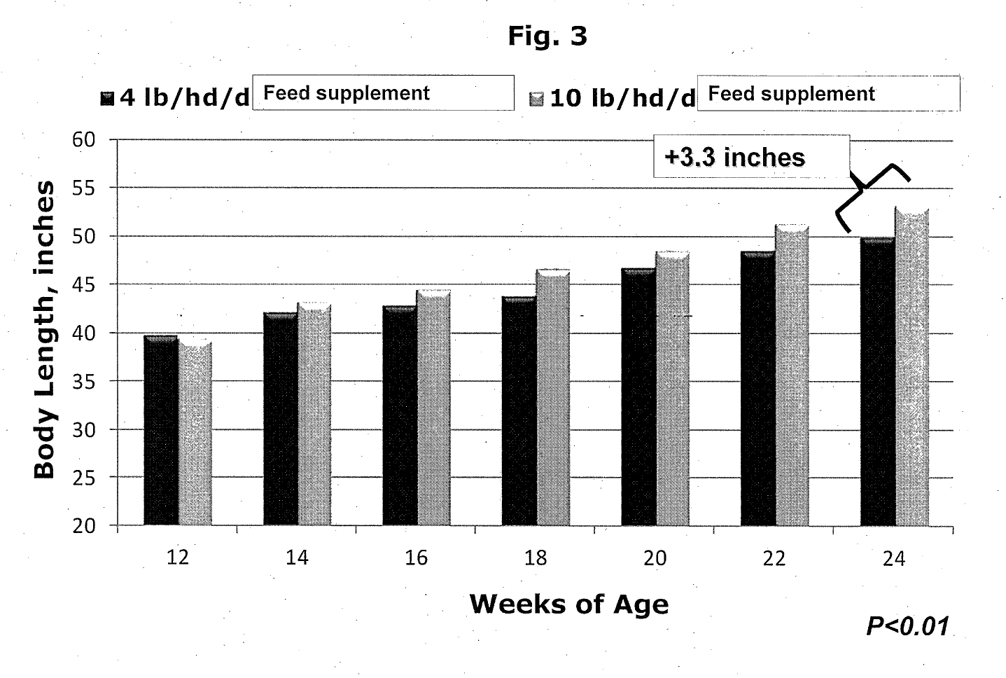

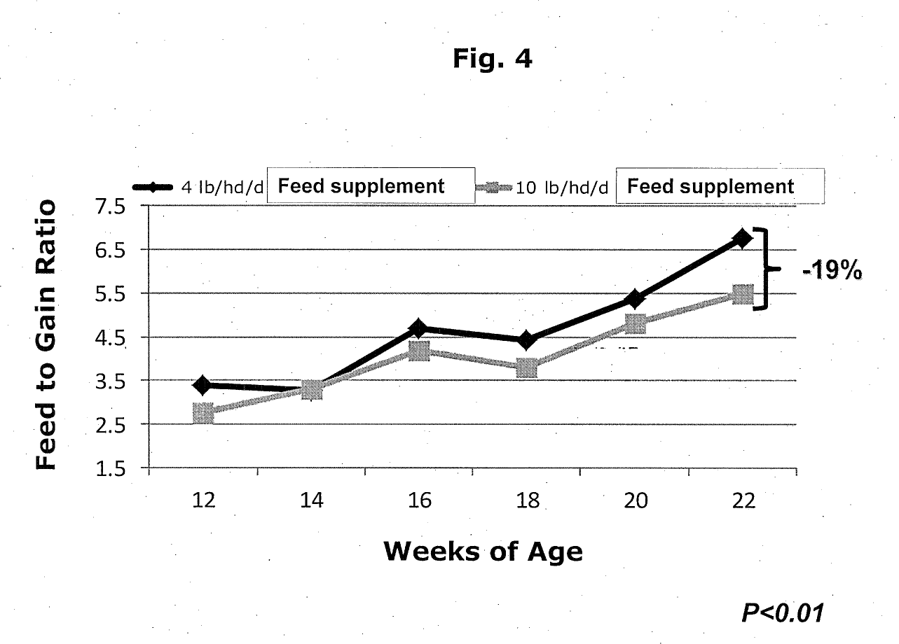

FIGS. 1-4 illustrate that calves fed 10 pounds of supplemental feed per day experienced higher rates of weight gain (FIG. 1), higher rates of growth, e.g., in height (FIG. 2) and length (FIG. 3), had a better average daily gain and an improved feed efficiency (FIG. 4) compared to calves fed 4 pounds of supplemental feed. At twenty-four weeks of age, compared to calves fed at a rate of 4 pounds of supplemental feed per day, on average, the calves fed at 10 pounds of supplemental feed per day weighed about 62 pounds more (or about a 15 percent increase), had an increased frame size with an increased height of about 1.7 inches (or about a 4 percent increase) and an increased length of about 3.3 inches (or about a 6 percent increase) had better average daily gain of about 0.7 pounds per day (or about a 34 percent increase) and an improved feed-to-gain ratio (or about a 10 percent improvement). Calves fed at the higher rate of supplemental feed had an overall average daily gain of 2.9 pounds per day compared to 2.2 pounds per day for calves fed at the lower rate, which is a 34 percent improvement. In addition, at the higher feeding rate of supplemental feed, the overall feed to gain ratio was 3.95, which is a 10 percent improvement of the calves fed at the lower feeding rate, which was 4.40.

Growing Ruminant Rumen Morphological Studies:

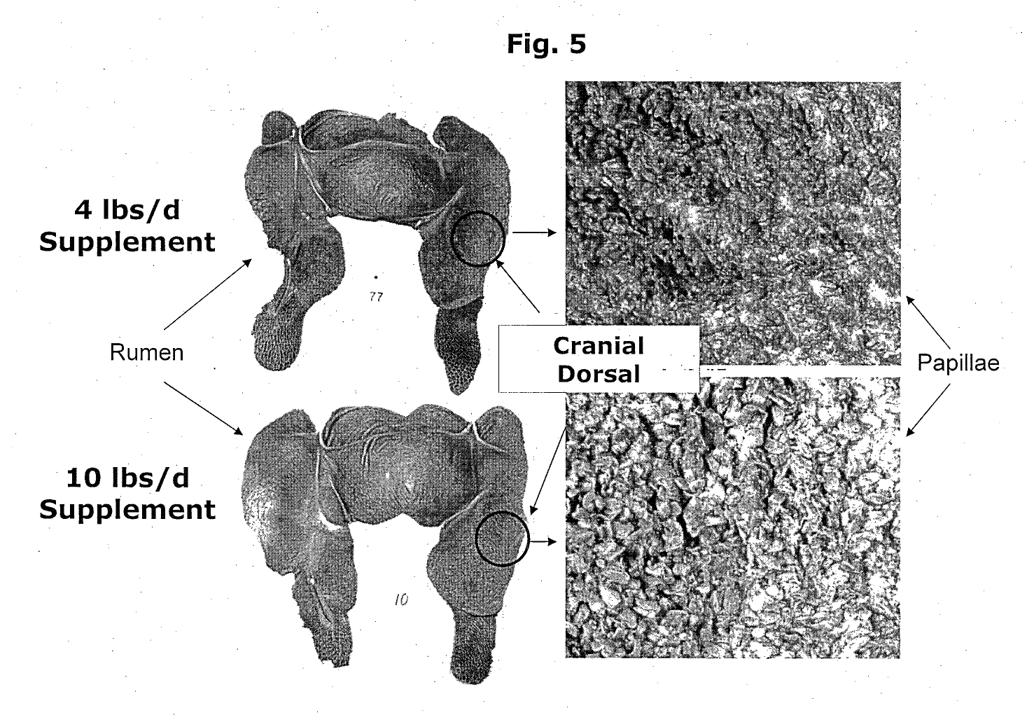

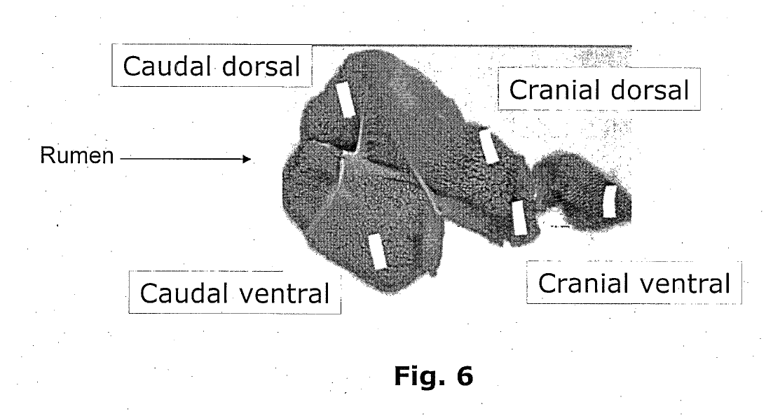

FIG. 5 illustrates two rumens and images of papillae samples taken at the same magnification from the cranial dorsal portion of the rumen, from two twenty-four week old sacrificial bull calves fed the two different compositions from Example 1. In FIG. 5, the cranial dorsal papillae within the rumen of the bull calves ingesting 4 pounds of supplemental feed per day is relatively less developed compared to papillae taken from the same portion of the bull calf ingesting 10 pounds of supplemental feed per day. For example, the papillae of the bull calf having ingested the supplemental feed at the higher rate per day over the twelve week period are larger, have more surface area and are more densely populated compared to the papillae of the bull calf having ingested the supplemental feed at the lower rate. The table below illustrates the differences in surface area in rumen papillae in the cranial ventral, cranial dorsal, caudal ventral and caudal dorsal portions of the rumen (see FIG. 6) taken at 24 weeks of age for growing ruminants ingesting 4 pounds of supplemental feed per day compared to 10 pounds of supplemental feed per day.

TABLE 2

| Rumen | Supplemental Feed | | | |
|---|---|---|---|---|
| Papillae, mm² | 4 lbs/d | 10 lbs/d | % Diff | P-Values |
| Cranial Ventral | 22.3 | 47.5 | +113% | 0.02 |
| Cranial Dorsal | 8.2 | 12.2 | +48% | ns |
| Caudal Ventral | 15.9 | 22.2 | +45% | ns |
| Caudal Dorsal | 13.0 | 25.7 | +97% | 0.06 |

Overall, the surface area of rumen papillae was 75 percent greater for the growing ruminant ingesting the higher rate of supplemental feed of 10 pounds per day compared to the ruminant ingesting the lower rate of 4 pounds per day thus indicating the absorptive capacity of the papillae is increased for the growing ruminant ingesting the supplemental feed at a rate of 10 pounds per day.

### Example 2

This example demonstrates a twelve week study period in which a group and 20 bull calves at about twelve weeks of age were fed feed compositions with differing amounts of supplemental feed, and the differences in calf performance and rumen morphology after ingesting the different levels of supplemental feed over the course of eight weeks and twelve weeks.

Prior to the study, all calves received 28:20 calf milk replacer until six weeks of age, as well as AMPLI-Calf® 22% textured starter from day 3 to twelve weeks of age.

Twelve-week-old calves (residing at the farm where they were calved (e.g., not shipped as in Example 1)) were separated by sex and then randomly separated into pens (20 bull calves in 9 pens) for five feeding groups. A first group of calves was provided 4 pounds of supplemental feed per calf per day, a second group was provided 8 pounds of supplemental feed per calf per day, a third group was provided 10 pounds of supplemental feed per calf per day, a fourth group was provided 12 pounds of supplemental feed per calf per day, and a fifth group had ad libitum access to the supplemental feed. The composition of the supplemental feed in each of the five feeding groups used in this example is shown in Table 3A.

TABLE 3A

| Component | (Wt. % Dry Basis) |
|---|---|
| Feed Pellets | 48.0 |
| Corn, Whole | 38.0 |
| Oats, Whole | 11.85 |
| Minor Ingredients | 2.15 |
| Total | 100 |

The composition of the feed pellets based on the overall weight of the supplemental feed is broken down in Table 3B below:

TABLE 3B

| Component | (Wt. % Dry Basis) |
|---|---|
| Soybean Meal 48% | 20.9 |
| Wheat Midds | 11.1 |
| Soybean Hulls | 4.7 |
| Cottonseed Hulls | 4.6 |
| SurePro | 2.2 |
| Calcium Carbonate | 1.7 |
| Molasses, Liquid | 0.7 |
| Monocal 21% | 0.7 |
| Salt | 0.5 |
| Minor ingredients | 0.9 |
| Total | 48 |

Table 3C includes a summary of particular nutrients present in the supplemental feed.

TABLE 3C

| Nutrient | (Wt. % Dry Basis) |
|---|---|
| Crude Protein | 20.4 |
| Acid detergent soluble fiber | 11.7 |
| (ADF) | |
| Neutral detergent soluble | 20.8 |
| fiber (NDF) | |
| Starch | 35.2 |
| Fat | 3.0 |
| Calcium | 1.1 |
| Phosphorous | 0.6 |

The calves also had ad libitum access to hay (e.g., alfalfa hay, 16% CP) during the twelve-week study period except for the fifth group, which had limited access to hay.

The total dry matter intake and hay intake of the calves were observed daily, and performance of the calves was observed every two weeks over the study period.

Growing Ruminant Developmental Studies:

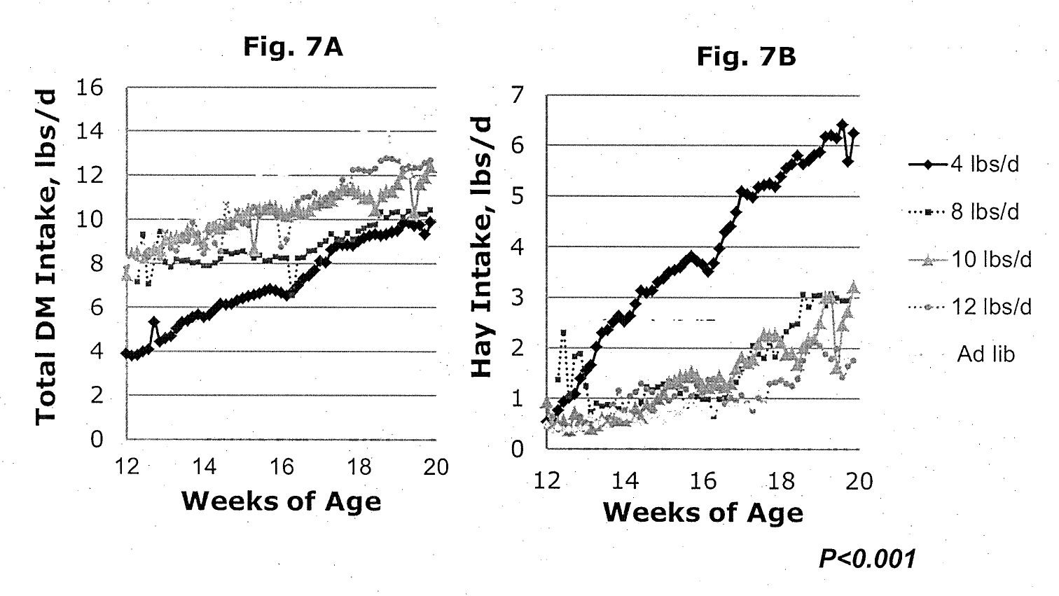

FIGS. 7A and 7B are graphs depicting differences in total dry matter intake (“DMI”) and hay intake, respectively, in growing calves that are fed supplemental feed at a rate of 4 pounds per day, 8 pounds per day, 10 pounds per day, 12 pounds per day and ad libitum over an eight week period from when the calves were 12 weeks of age to 20 weeks of age. As the amount of supplemental feed increased, the total DMI generally increased (FIG. 7A), while the intake of hay generally decreased (FIG. 7B). After 20 weeks of age, or 8 weeks in the study, calves ingesting the supplemental feed ad libitum and amounts of supplemental feed at least at 8 pounds per day exhibited the highest daily rate of total DMI and the lowest hay intake (except that the ad libitum supplemental feed group was fed limited hay), while calves ingesting supplemental feed at a rate of 4 pounds per day had the lowest DMI and highest hay intake.

Table 4 below illustrates the weight gain characteristics of the growing ruminants including: weight gain, the percent weight gain increase over the 4 pound per day feeding rate of the supplemental feed, the hip height gain in inches, and the hip height increase over the 4 pound per day feeding rate for the twenty week old calves studied in Example 2.

TABLE 4

| | Weight Gain at 20 Weeks of Age, | | | | |
|---|---|---|---|---|---|
| | after 8 weeks of feeding, P < 0.05 | | | | |
| | 4 lbs/day | 8 lbs/day | 10 lbs/day | 12 lbs/day | Ad lib |
| WT Gain, lbs | 113 | 152 | 154 | 160 | 181 |
| Increase over | | +39 | +41 | +47 | +68 |
| 4 lbs/d rate | | | | | |
| Hip HT Gain, | 4.28 | 4.75 | 4.69 | 4.88 | 4.94 |
| inches | | | | | |
| Increase over | | +0.47 | +0.41 | +0.60 | +0.66 |
| 4 lbs/d rate | | | | | |

From Table 4, weight gain generally increased as the rate of supplemental feed increased. Although the gain in height of the calves for the 8 pound, 10 pound, 12 pound and ad libitum feeding rates increased over the 4 pound feeding rate, the increase was not consistent with increasing feeding rates of the supplemental feed (e.g., the calves in the 10 pound feeding rate had a lower height gain compared to the calves in the 8 pound feeding rate).

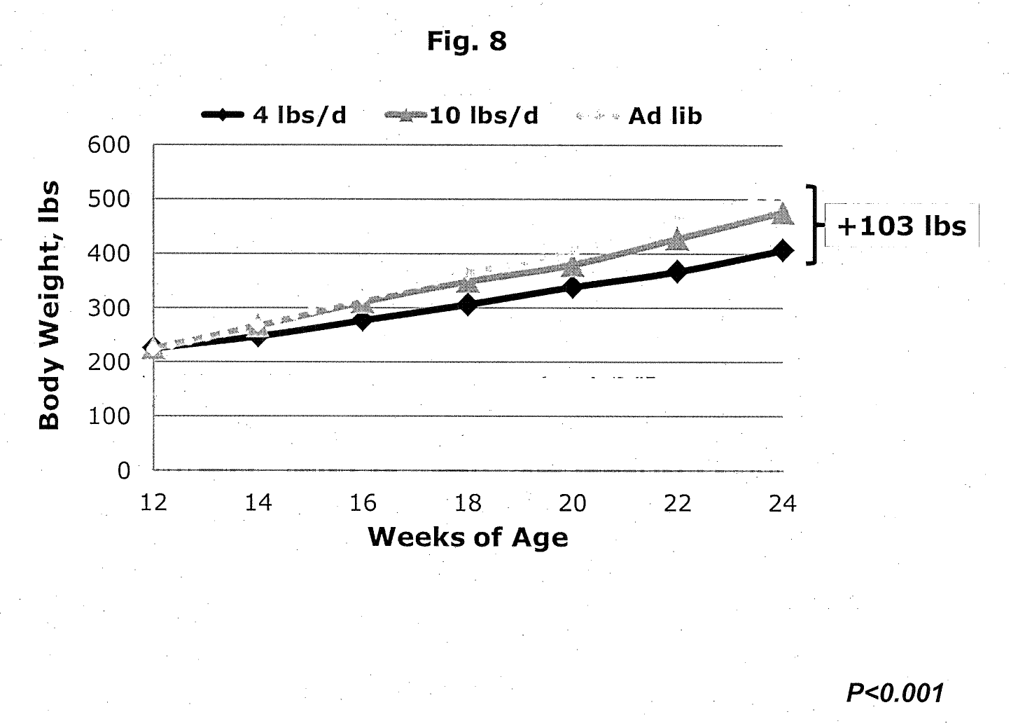

FIG. 8 is a graph depicting differences in body weight in growing calves fed 4 pounds of supplemental feed, 10 pounds of supplemental feed and ad libitum supplemental feed over the twelve-week period of Example 2. Calves fed the supplemental feed at higher rates had greater body weight at 24 weeks, and compared to the calves receiving 4 pounds of the supplemental feed per day, calves provided ad libitum access to the supplemental feed were about 103 pounds heavier and calves provided 10 pounds of supplemental feed were about 70 to about 80 pounds heavier. Table 5A below illustrates the average daily gain of the calves ingesting the various levels of supplemental feed at 20 weeks of age.

TABLE 5A

| | 20 wks of age, P < 0.01 | | | | |
|---|---|---|---|---|---|
| lbs/d | 4 lbs/d | 8 lbs/d | 10 lbs/d | 12 lbs/d | Ad Lib |
| Overall ADG | 2.1 | 2.7 | 2.7 | 2.9 | 3.1 |

Table 5B below illustrates the average daily gain of the calves ingesting the various levels of supplemental feed at 24 weeks of age.

TABLE 5B
24 wks of age, P < 0.01

| lbs/d | 4 lbs/d | 10 lbs/d | Ad Lib |
|---|---|---|---|
| Overall ADG | 2.1 | 2.7 | 3.1 |

Based on Tables 5A and 5B, the overall average daily gain for the growing ruminants increased as the rate of supplemental feed increased. At twenty-four weeks of age, the overall performance of the growing ruminants increased and the feed-to-gain ratio was 3.9 for the group ingesting 4 pounds of supplemental feed per day, was 3.8 for the group ingesting 10 pounds of supplemental feed per day, and was 4.0 for the group ingesting ad libitum amounts of supplemental feed per day.

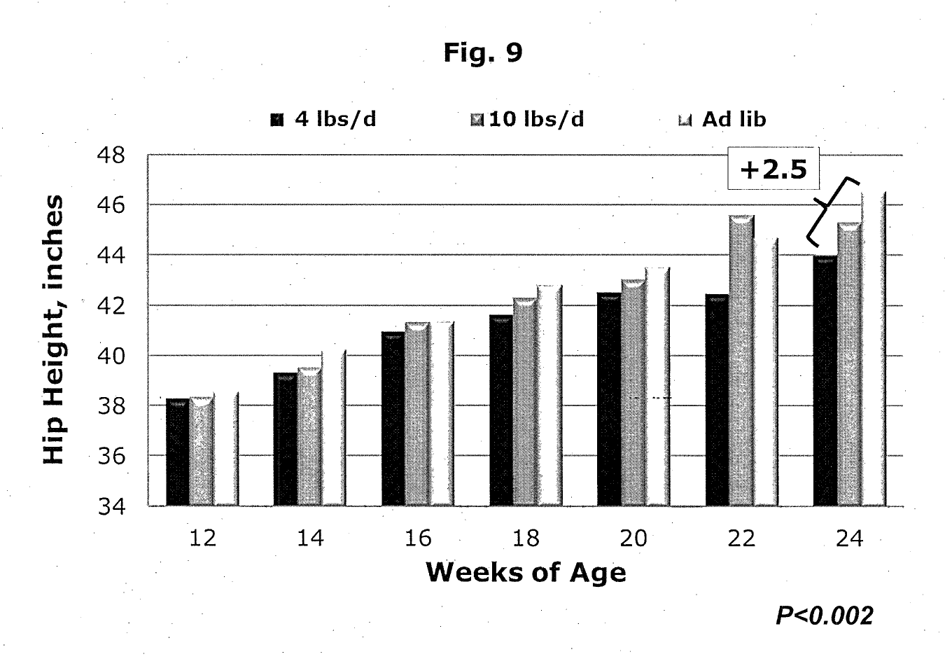

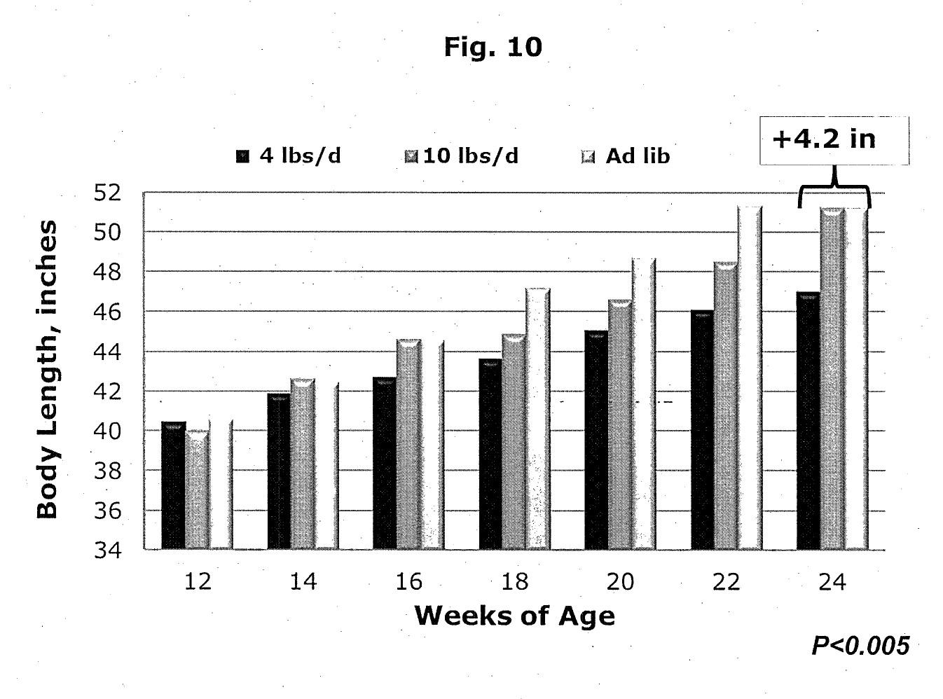

FIGS. 9-10 illustrate the growing ruminants fed higher rates of supplemental feed per day (e.g., 10 pounds and ad libitum) experienced higher rates of frame growth in height (FIG. 9) and in length (FIG. 10), compared to calves fed 4 pounds of supplemental feed. After twenty-four weeks, the growing heifers ingesting 8 pounds and 12 pounds per day grew in frame structure by about the same amount in height and length, which may indicate that growing heifers may respond equally to supplemental feed provided at rates ranging from 8 pounds to 12 pounds per day.

In Example 2, at twenty-four weeks of age, calves fed 10 pounds of supplemental feed per day with hay ad libitum outpaced calves fed 4 pounds of supplemental feed per day with hay ad libitum. For example, on average, the calves fed at 10 pounds of supplemental feed per day weighed about 70 pounds more (or a 17 percent increase), had an increased frame size with an increased height of about 1.2 inches (or about a 3 percent increase) and an increased length of about 4.7 inches (or about a 10 percent increase) had better average daily gain of about 0.6 pounds per day (or about a 29 percent increase) and an improved feed-to-gain ratio (or about a 3 percent improvement).

Table 6 below illustrates calves fed increased rates of the supplemental feed were taller and longer in frame and were heavier.

TABLE 6

| Calves | | | |
|---|---|---|---|
| *Treatment at 20 | | | |
| weeks of age | 4 lbs/day | 8 lbs/day | 10 lbs/day |
| WT Gain, lbs. | 101 | 136 | 128 |
| | | +35 | +27 |
| Hip HT Gain, in. | 5.1 | 6.0 | 6.6 |
| | | +0.9 | +1.5 |
| Body Length Gain, in. | 3.3 | 4.5 | 4.3 |
| | | +1.2 | +1.0 |
| 20 Wk Body | 3.1 | 3.2 | 3.1 |
| Condition Score | | | |

*Each treatment represents two calves

Growing Ruminant Rumen Morphological Studies:

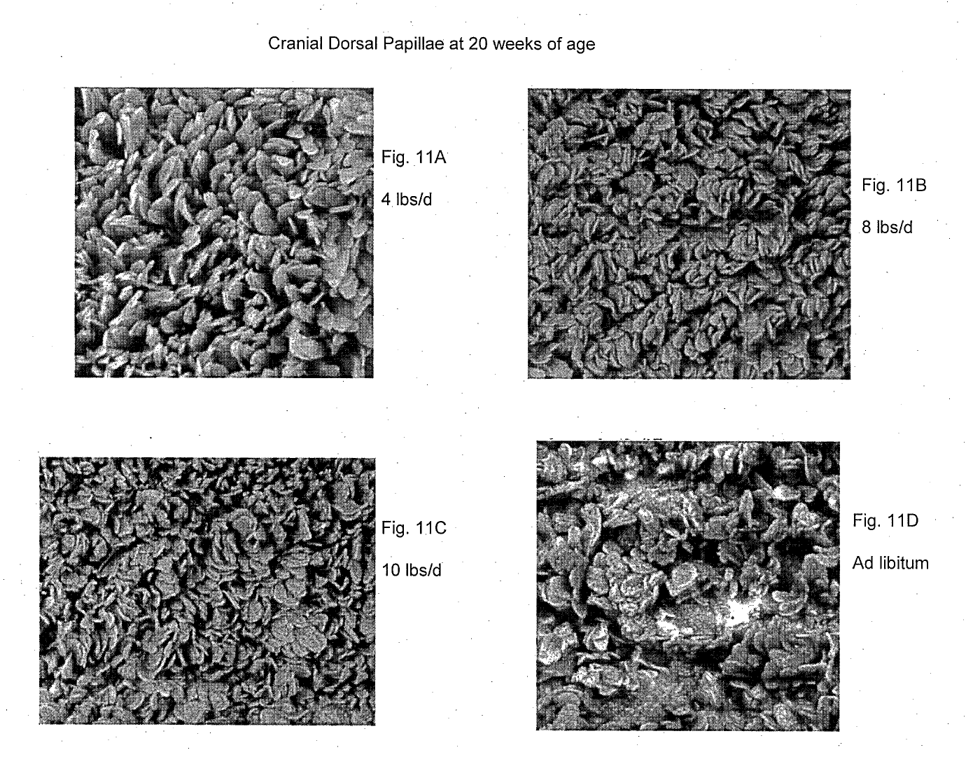

FIGS. 11A-11D illustrate four images of papillae samples taken at the same magnification from the cranial dorsal portion of the rumen from four, twenty-week-old sacrificial bull calves fed the four different levels of the supplemental feed (4 lbs/day, 8 lbs/day, 10 lbs/day and ad libitum) from Example 2. In FIGS. 11A-11D, the cranial dorsal papillae within the rumen of the bull calf ingesting 4 pounds of supplemental feed per day is relatively less developed compared to papillae taken from the same portion of the bull calf ingesting 8 pounds, 10 pounds and ad libitum amounts of supplemental feed per day. For example, the papillae of the bull calf having ingested the supplemental feed at the higher rate per day over the eight-week period are more densely populated and have a deeper brown color compared to the papillae of the bull calf having ingested the supplemental feed at the lower rate (e.g., 4 pounds per day). The dense population of papillae provides more surface area for nutrient absorption and the deeper brown color may indicate changes in keratin layer of papillae. From FIGS. 11A-11D, the rumen development of the growing ruminant is greater for the calves with the increased feeding rate compared to the 4 pound per day rate, and shows small changes in feeding rate can affect papillae appearance. However, the inconsistent color and non-uniformly spaced papillae in the sample taken from the calf ingesting the supplemental feed ad libitum (FIG. 11D) may indicate that the calf may have ingested an excessive amount of supplemental feed for optimal rumen development, such as due to pH changes (e.g., pH drops) by potentially excessive amounts of ingested grains and carbohydrates.

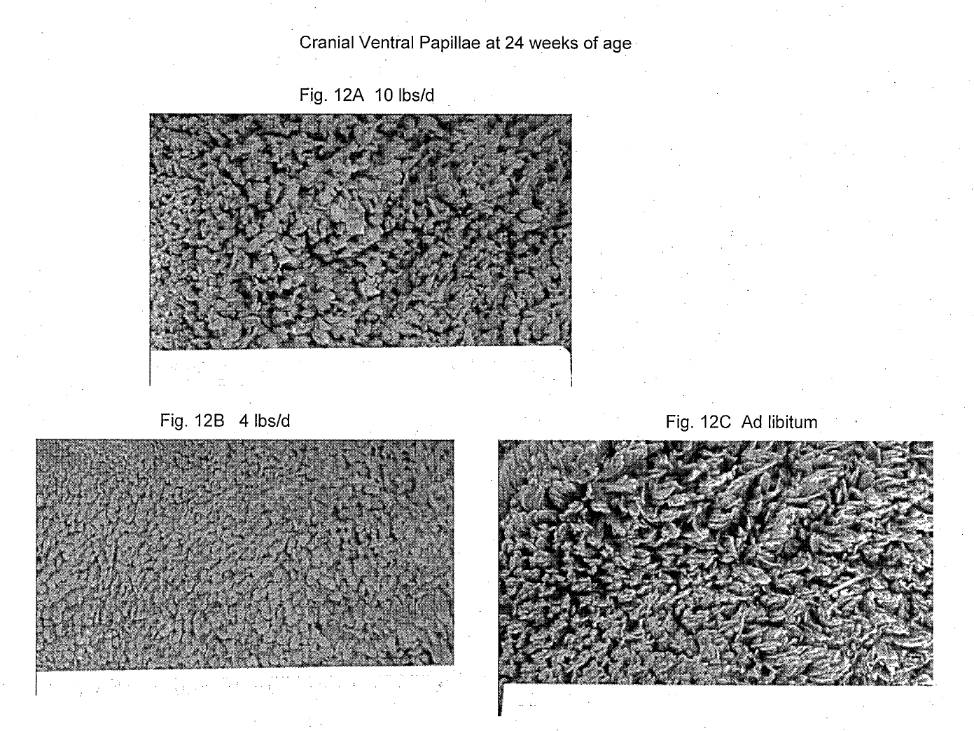

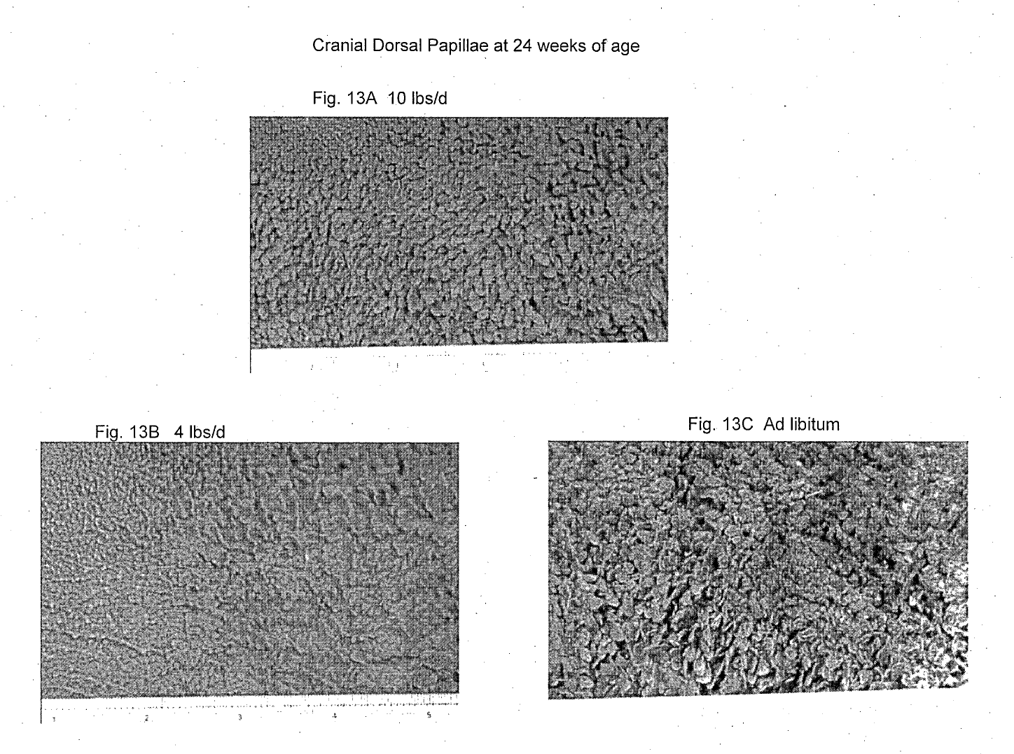

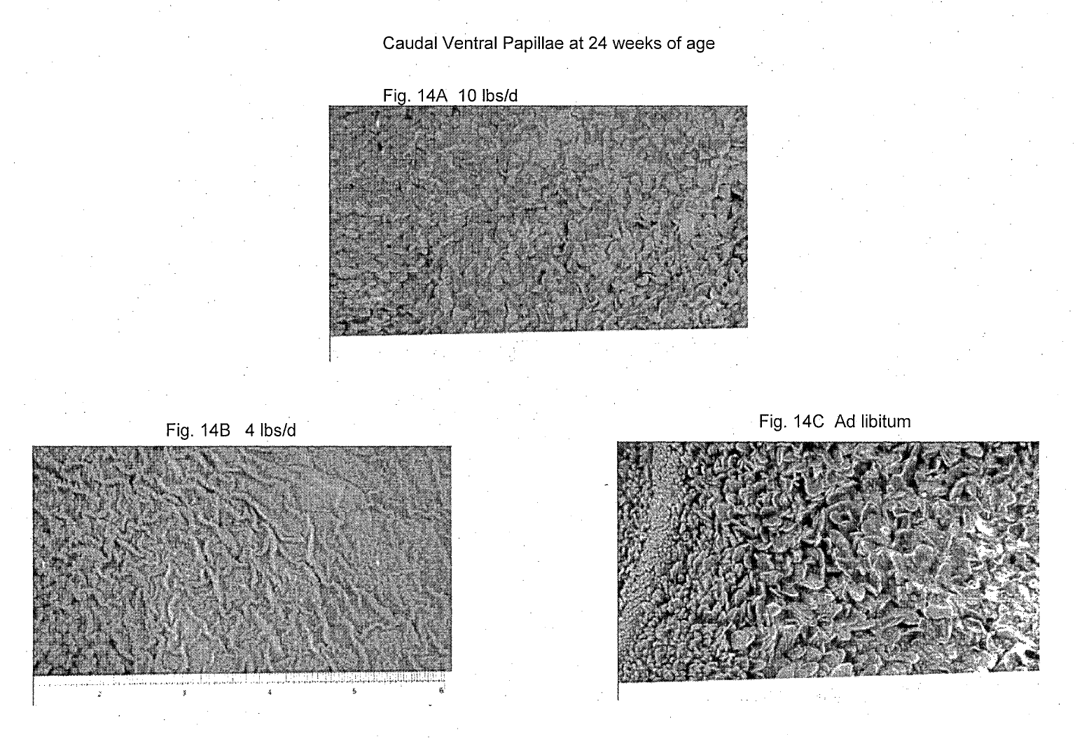

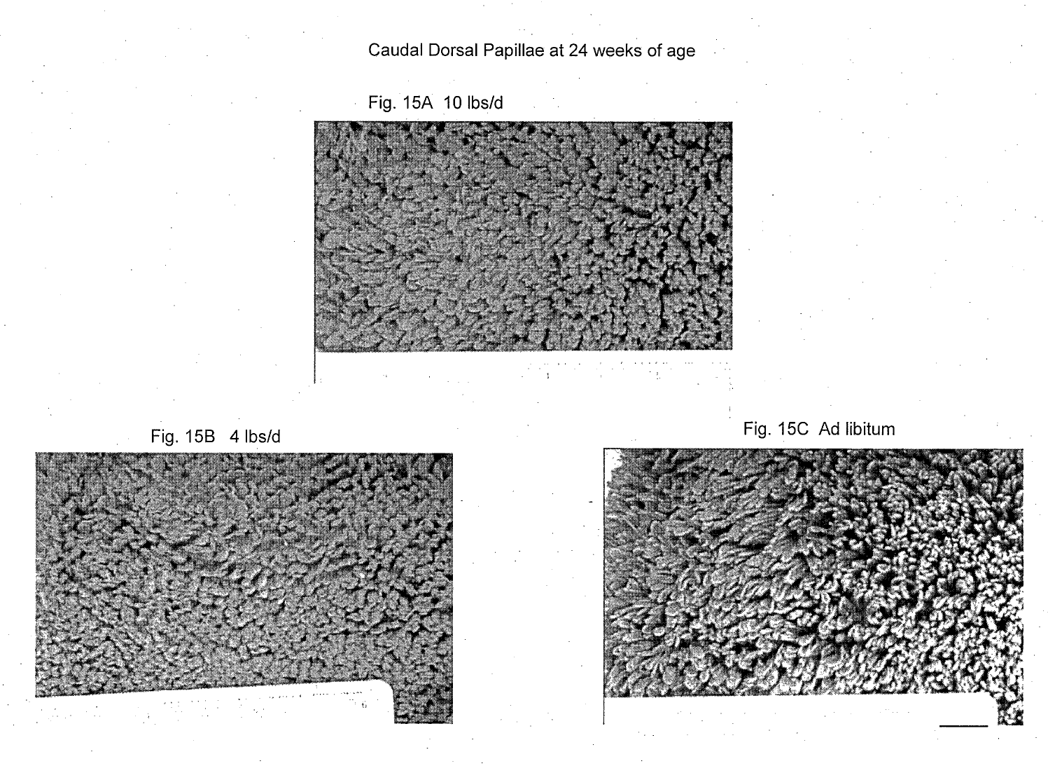

FIGS. 12A-12C, 13A-13C, 14A-14C, 15A-15C illustrate ruminal papillae from three sacrificial bull calves each at twenty-four weeks of age at the cranial ventral (FIGS. 12A-12C), the cranial dorsal (FIGS. 13A-13C), the caudal ventral (FIGS. 14A-14C) and the caudal dorsal (FIGS. 15A-15C) portions of the rumen, where the growing bull calves were fed either 4 pounds, 10 pounds or ad libitum amounts of supplemental feed over the twelve week period of Example 2. The growing ruminants were fed ad libitum hay except for the group receiving ad libitum supplemental feed, which received limited hay at a rate of about 1.0 pounds per day. In FIGS. 12A-15C, the papillae within the rumen of the bull calf ingesting 4 pounds of supplemental feed per day remains relatively less developed compared to papillae taken from the same portion of the bull calf ingesting 10 pounds and ad libitum amounts of supplemental feed per day. In addition, the coloring of the papillae of the calf ingesting the supplemental feed at a rate of 10 pounds per day is a deeper brown compared to the papillae of the calf ingesting the supplemental feed at a rate of 4 pounds per day. However, the discolored or grey coloring of the papillae in the sample taken from the calf ingesting the supplemental feed ad libitum (FIGS. 12C, 13C, 14C, 15C) indicates that calf may have ingested an excessive amount of supplemental feed for optimal rumen development. Overall, the rumens of the growing ruminants ingesting 10 pounds of supplemental feed per day was more densely populated with papillae having a larger surface area and brownish coloring compared to the rumens of the growing ruminants ingesting 4 pounds of supplemental feed having a smaller population of papillae with less surface area and less sub-mucosa layer resulting in a decreased absorptive capacity. The rumens of growing ruminants ingesting ad libitum amounts of supplemental feed per day, while densely populated with papillae, had a grey color indicative of parakeratosis or hyperkeratosis (hardening) of the papillae resulting in a reduced absorptive capacity and ruminal abscesses were detected.

The tables below illustrate the differences in surface area in rumen papillae in the cranial ventral, cranial dorsal, caudal ventral and caudal dorsal portions of the rumen (see FIG. 6) taken at twenty weeks of age (Table 7) and twenty-four weeks of age (Table 8) for growing ruminants that ingested 4 pounds, 8 pounds (Table 7 only), 10 pounds, 12 pounds (Table 7 only) and ad libitum amounts of supplemental feed per day.

TABLE 7

| 20 weeks of Age | 4 | 8 | 10 | 12 | Ad lib | P-values |
|---|---|---|---|---|---|---|
| Papillae, mm² | | | | | | |
| Cranial Ventral | 42 | 64 | 45 | 52 | 43 | ns |
| Cranial Dorsal | 21 | 24 | 35 | 20 | 42 | ns |
| Caudal Ventral | 22 | 38 | 37 | 38 | 48 | ns |
| Caudal Dorsal | 22 | 31 | 37 | 26 | 37 | ns |

TABLE 8

| 24 weeks of Age | 4 | 10 | Ad lib | P-values |
|---|---|---|---|---|
| Papillae, mm² | | | | |
| Cranial Ventral | 33 | 49 | 54 | 0.090 |
| Cranial Dorsal | 11 | 33 | 52 | 0.003 |
| Caudal Ventral | 13 | 37 | 61 | 0.001 |
| Caudal Dorsal | 19 | 32 | 44 | 0.030 |

The differences in surface area of the papillae in the rumens of the various calves at twenty weeks not being statistically significant combined with the increased surface area of the papillae of the growing ruminants ingesting the higher rates of supplemental feed at twenty-four weeks may indicate that the supplemental feed should be provided to the calf beyond twenty weeks of age and up to twenty-four weeks of age. Overall, the surface area of rumen papillae at twenty-four weeks of age was 118 percent greater for the growing ruminant ingesting the higher rates of supplemental feed compared to the ruminant ingesting the lower rate of 4 pounds per day.

The tables below illustrate the differences in rumen morphology including: rumen weight, empty rumen weight, rumen contents, percent dry matter of contents, rumen contents, and rumen pH taken at twenty weeks of age (Table 9) and twenty-four weeks of age (Table 10) for growing ruminants ingesting 4 pounds, 8 pounds (Table 9 only), 10 pounds, 12 pounds (Table 9 only) and ad libitum amounts of supplemental feed per day.

TABLE 9

| | | | | | Ad | P- |
|---|---|---|---|---|---|---|
| 20 weeks of Age | 4 | 8 | 10 | 12 | lib | values |
| Rumen WT, lbs | 58.8 | 48.0 | 45.9 | 43.3 | 45.8 | ns |
| Empty Rumen WT, lbs | 9.4 | 10.8 | 11.9 | 11.6 | 11.7 | ns |
| Rumen Contents, Wet Wt, lbs | 49.4 | 37.2 | 34.0 | 31.8 | 34.0 | ns |
| % DM of contents | 16.3 | 18.6 | 18.3 | 21.7 | 20.4 | 0.124 |
| Rumen Contents, DM lbs | 1.5 | 2.0 | 2.2 | 2.5 | 2.4 | 0.002 |
| Rumen pH | 6.3 | 6.6 | 6.7 | 6.3 | 6.1 | 0.126 |

TABLE 10

| 24 weeks of Age | 4 | 10 | Ad lib | P-values |
|---|---|---|---|---|
| Rumen WT, lbs | 73.8 | 61.2 | 59.2 | 0.071 |
| Empty Rumen WT, lbs | 10.6 | 15.4 | 17.1 | <0.001 |
| Rumen Contents, Wet Wt, lbs | 63.2 | 45.8 | 42.2 | 0.022 |
| % DM of contents | 14.0 | 17.4 | 23.1 | <0.001 |
| Rumen Contents, DM lbs | 1.5 | 2.7 | 4.0 | <0.001 |
| Rumen pH | 6.6 | 6.7 | 6.1 | 0.045 |

The differences in rumen weight, the empty rumen weight, and the rumen contents of the various calves at twenty weeks not being statistically significant combined with the increased weight of the empty rumen and rumen contents in the growing ruminants ingesting the higher rates of supplemental feed at twenty-four weeks, may indicate that the supplemental feed should be provided to the calf beyond twenty weeks of age and up to twenty-four weeks of age. Overall, calves fed the higher rates of supplemental feed had larger rumens compared to the ruminant ingesting the lower rate of 4 pounds per day. However, the decreased pH level of the group of ruminants ingesting ad libitum supplemental feed relates to a more acidic environment caused by more grain (starch) feeding, which may, in turn, lead to parakeratosis, hyperkeratosis or abscesses or other harmful effects.

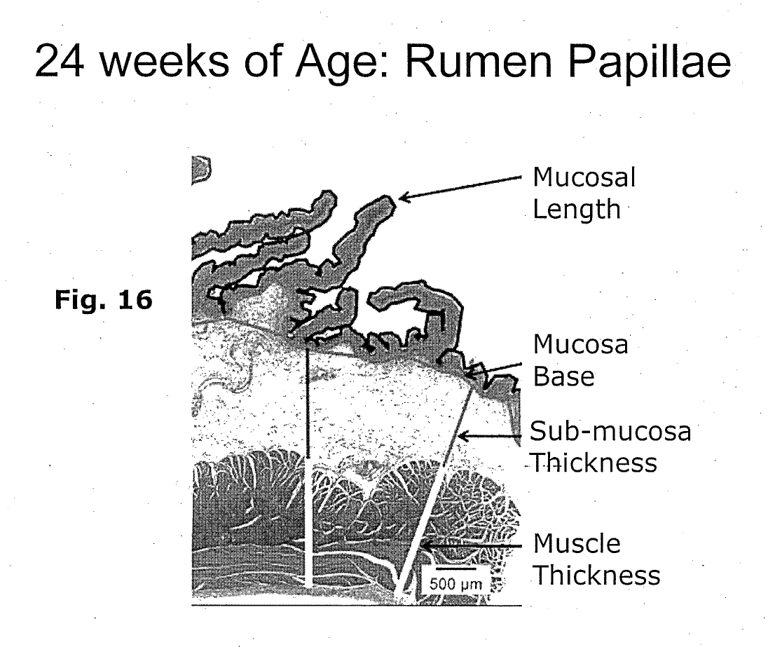

Table 11 illustrates the differences in the papillae in the thickness of the muscle, sub-mucosa and mucosa (see FIG. 16) taken at twenty-four weeks of age for growing ruminants ingesting 4 pounds, 10 pounds, and ad libitum amounts of supplemental feed per day.

TABLE 11

| Rumen | | | | |
|---|---|---|---|---|
| Papillae | 4 | 10 | Ad | |
| Thickness, mm | lbs/d | lbs/d | lib | P-value |
| Muscle | 1.7 | 2.2 | 1.5 | 0.008 |
| Sub-Mucosa | 0.4 | 0.9 | 0.5 | .004 |
| Mucosa | 47.7 | 57.7 | 59.2 | 0.16 |

The papillae muscle and sub-mucosa thickness in the twenty-four week old growing ruminant were thicker by a statistically significant amount for the growing ruminant ingesting 10 pounds of supplemental feed per day compared to the growing ruminant ingesting 4 pounds of supplemental feed per day indicating the morphology of the papillae is affected by increased amounts of supplemental feed in the diet of the growing ruminant. For the ruminant ingesting ad libitum amounts of supplemental feed, the muscle and sub-mucosa were thinner by a statistically significant amount compared to the growing ruminant ingesting 10 pounds of supplemental feed per day. The data presented in Table 11 may indicate that the growing ruminant ingesting about 10 pounds of supplemental feed per day optimizes papillae development, while the 4 pound and ad libitum feeding rates of the supplemental feed may result in underdevelopment (e.g., 4 pound feeding rate) or over-stimulation (e.g., ad libitum feeding rate) leading to stunted growth or atrophy. Accordingly, while the growing ruminant developmental studies of Example 2 may appear to indicate that growing ruminants with ad libitum access to supplemental feed performs equally or better than growing ruminants ingesting about 10 pounds or between about 8 pounds to about 12 pounds of supplemental feed, the growing ruminant rumen morphological studies of Example 2 indicate that ad libitum feeding of the supplemental feed can be detrimental to the rumen and papillae tissue, which may negatively influence ruminant longevity by reducing the absorptive capacity of the rumen tissue thereby reducing performance (e.g., increased age to breeding, decreased milk production, reduced rate of weight gain, reduced feed efficiency and reduced number of lactations).

### Example 3

This example demonstrates data from five field trials conducted over a twelve week study period in which calves (heifers) at about twelve weeks of age were fed feed compositions with either 3-4 pounds of commercial feed or 10 pounds of the supplemental feed provided in Table 1A.

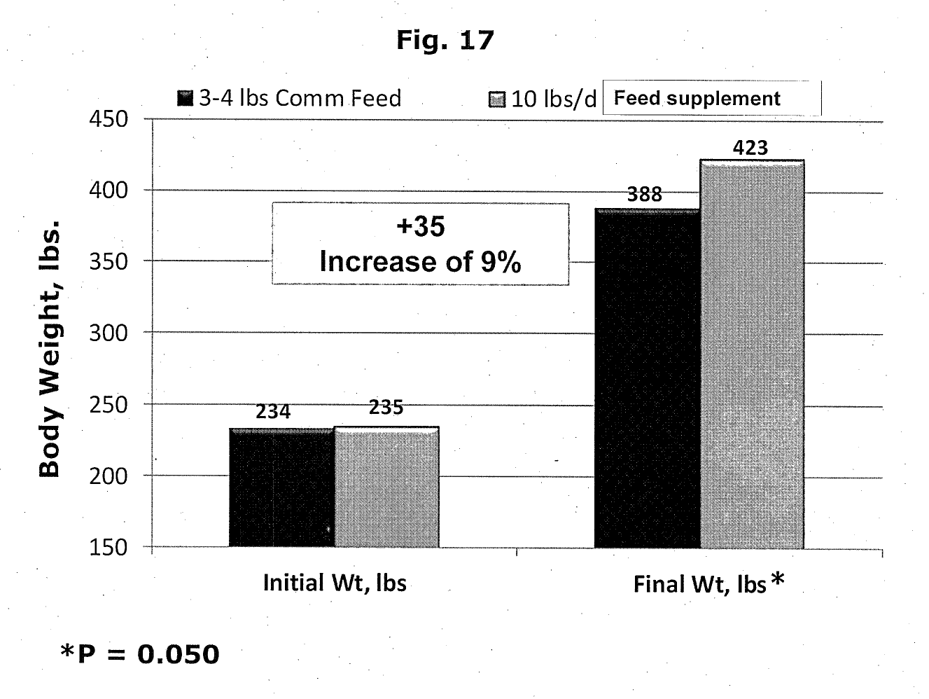

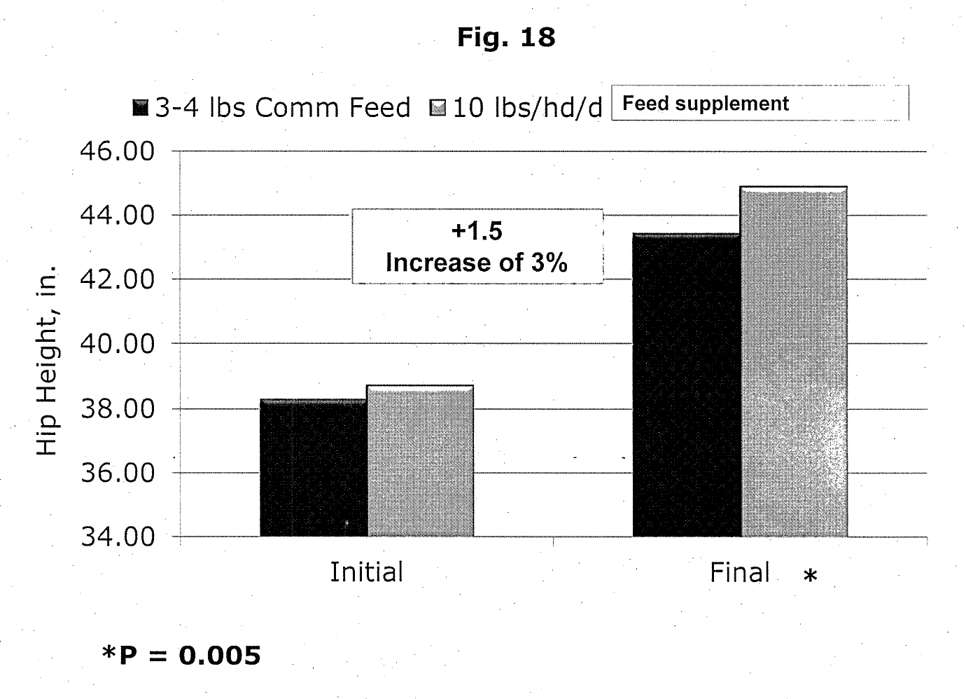

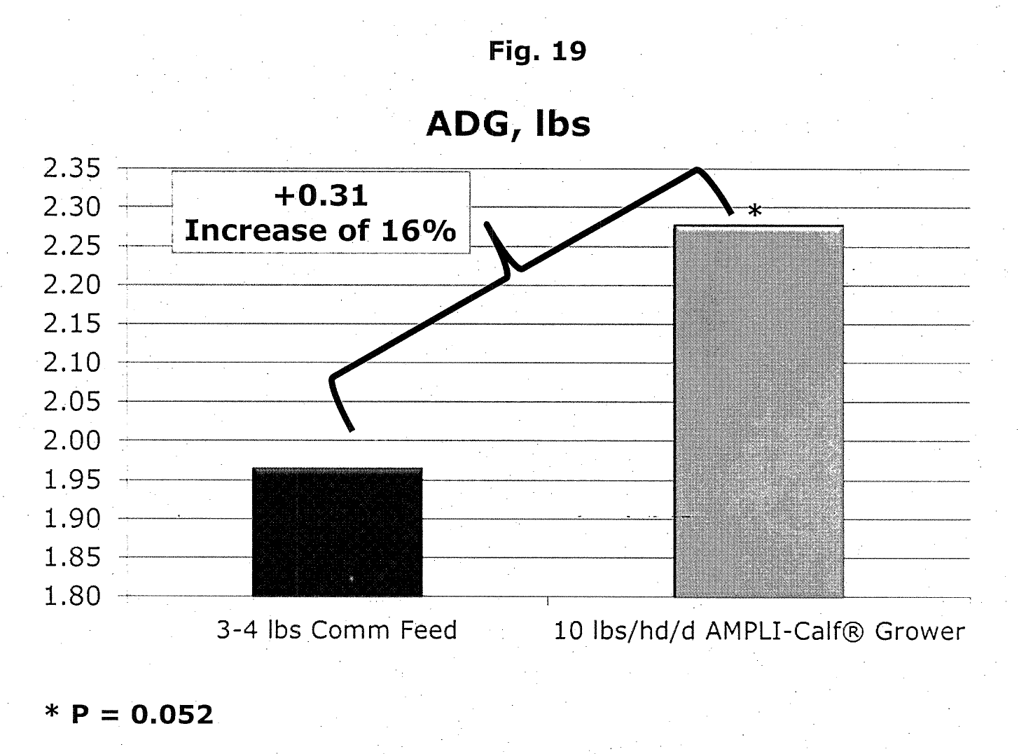

FIGS. 17-19 illustrate that calves fed 10 pounds of supplemental feed per day had a higher final body weight (FIG. 17), were taller (FIG. 18), and had a better average daily gain and feed efficiency (FIG. 19) compared to calves fed 3-4 pounds of the commercial feed. At the end of the field trials, compared to calves fed at a rate of 3-4 pounds of commercial feed per day, on average, the calves fed at 10 pounds of supplemental feed per day weighed about 35 pounds more (or about a 9 percent increase), had an increased frame size with an increased height of about 1.5 inches (or about a 3 percent increase) and had better average daily gain of about 0.31 pounds per day (or about a 16 percent increase).

### Example 4

This example demonstrates a twelve-week study period in which a group of 18 calves from birth until about twelve weeks of age were orally administered milk replacers and supplemental feed compositions with differing amounts nutrients. Because the calf is still developing the rumen at this age, different sources of nutrients (e.g., protein, fat, starch, and fiber) may promote better rumen development and subsequent performance. In young calves less than twelve weeks of age, as consumption of dry feeds increased rumen papillae began to appear as early as four weeks of age. By eight weeks of age, rumen papillae were distinct and elongating; and by twelve weeks of age, were of size and shape capable of absorbing nutrients (VFAs) of rumen microbial fermentation. As the calf grows and diet changes from milk to dry feeds, the primary site of digestion moves from the abomasum to the rumen, promoting ruminant development. In this study, the calves exhibited differences in development (e.g., frame growth and weight) and rumen morphology after ingesting the feed over the course of twelve weeks.

During the study, calves were assigned three treatment groups according to three different nutrient planes: high, medium, or low; with the low nutrient plane being a conventional feeding system with historical amount of nutrients, that in prior approaches, would have been typically followed by producers. In the high nutrient plane (HNP), calves received 28:20 calf milk replacers (28 percent protein and 20 percent fat) at a rate of 1.8 lbs/day through the first week and 2.5 lbs/day from week two until six weeks of age. HNP calves were provided starter feed with 25 percent crude protein (dry weight) ad libitum. In the medium nutrient plane (MNP), calves received 22:20 calf milk replacer at a rate of 1.5 lbs/day until six weeks of age. MNP calves were provided starter feed with 23 percent crude protein (dry basis), ad libitum. In the low nutrient plane (LNP), calves received 20:20 calf milk replacer at a rate of 1.0 lbs/day until six weeks of age. LNP calves were provided starter feed with 21 percent crude protein (dry basis), ad libitum. Starter feed offered and refused was measured daily. All calves were weaned starting on week six and finishing at week seven of age. At approximately six weeks of age, calves were fed milk replacer only once a day for a week, regardless of treatment, thereby reducing the amount of calf milk replacer to half the amount stated in the above HNP, MNP and LNP treatments.

Table 12A includes a summary of feed components present in the starter feed used in Example 4.

TABLE 12A
Starter Supplement Feed, 0 to 12 wk of age

| Components | HNP Starter | MNP Starter | LNP Starter |
|---|---|---|---|
| (Wt. % Dry Basis) | Composition | Composition | Composition |
| Soybean Meal | 34.0 | 27.5 | 20.9 |
| Corn | 28.3 | 28.3 | 34.4 |
| Oats | 14.1 | 14.1 | 9.1 |
| Wheat Midds | 9.9 | 16.4 | 21.8 |
| Cottonseed Hulls | 4.1 | 4.1 | 0.0 |
| Molasses | 4.8 | 4.8 | 5.5 |
| Calcium Carbonate | 2.8 | 2.9 | 2.6 |
| Corn gluten feed | 0.0 | 0.0 | 2.9 |
| Salt | 0.8 | 0.8 | 1.1 |
| Vitamin & Trace | 1.1 | 1.2 | 1.6 |
| Minerals | | | |

Table 12B includes a summary of particular nutrients present in the starter feed.

TABLE 12B
Nutrient Profile of Starter Feed, 0 to 12 wk age

| Nutrient | HNP Starter | MNP Starter | LNP Starter Feed |
|---|---|---|---|
| (Wt. % Dry Basis) | Feed Nutrients | Feed Nutrients | Nutrients |
| Crude Protein | 25.40 | 23.2 | 20.9 |
| Acid detergent | 9.8 | 10.1 | 7.12 |
| soluble fiber (ADF) | | | |
| Neutral detergent | 17.9 | 19.6 | 17.4 |
| soluble fiber (NDF) | | | |
| Starch | 29.2 | 30.1 | 33.4 |
| Fat | 2.9 | 3.1 | 3.43 |
| Calcium | 1.3 | 1.31 | 1.31 |
| Phosphorous | 0.51 | 0.53 | 0.61 |

Statistical analysis was completed for body weight, hip height, body length, total dry matter intake, and papillae surface area. For purposes of comparing data in Example 4, P values are provided in the tables and figures of 0.05, or lower, are considered statistically significant. Thus, where a P value of 0.05 or less is returned for particular results, it is assumed that the differing results are fully explained by the test regimen, i.e.: the feeding of the increased rate(s) of protein the MNP and LNP treatment groups.

Growing Ruminant Developmental Studies:

Table 13A below illustrates growth of calves thru eight weeks of age in Example 4 based on: weight gain, hip height increase, average daily gain, and accumulative milk replacer intake and dry matter intake (6 per treatment). Treatment effect (Trt. Effect) means that one or more of the treatments are different from the other. Treatment by week interaction indicates that not all treatments responded in a similar pattern through time.

TABLE 13A

| | Growth at 8 Weeks of Age, | | | | |
|---|---|---|---|---|---|
| | after 8 weeks of feeding, P < 0.05 | | | | |
| | HNP | MNP | LNP | | Trt. Effect, |
| | Group | Group | Group | SE | P = |
| WT Gain, lbs | 76 | 60 | 59 | 4.9 | 0.04 |
| Hip Height | 1.77 | 1.36 | 1.15 | 0.42 | 0.05 |
| increase | | | | | |
| Average daily gain | 1.4 | 1.11 | 1.09 | 0.09 | 0.05 |
| Accumulative Milk | 514 | 410 | 347 | 6 | 0.001 |
| Intake | | | | | |
| Accumulative Dry | 49 | 61 | 85 | 8.5 | 0.02 |
| Matter Intake Feed | | | | | |
| supplement | | | | | |

From Table 13A, weight gain (e.g., overall gain, hip height increase, and average daily gain) and milk replacer intake generally increased as the feeding rate increased delivering more nutrients to the calf in the form of milk replacer. It is believed that because the HNP group received an increased amount of nutrients from milk replacer compared to the MNP and LNP groups, the total dry matter intake of the starter feed was lower since the animal ingested its required nutrients through the milk replacer.

Table 13B below illustrates growth of twelve week old calves studied in the three treatment groups in Example 4 based on: weight gain, hip height increase, average daily gain, accumulative dry matter intake and feed to gain ratio (4 per treatment).

TABLE 13B

| | Growth at 12 Weeks of Age, | | | | |
|---|---|---|---|---|---|
| | after 12 weeks of feeding, P < 0.05 | | | | |
| | HNP | MNP | LNP | | Trt. Effect, |
| | Group | Group | Group | SE | P = |
| WT Gain, lbs | 144 | 128 | 133 | 9.9 | 0.54 |
| Hip Height | 3.11 | 2.72 | 2.32 | 0.23 | 0.11 |
| increase | | | | | |
| Average daily gain | 1.87 | 1.71 | 1.84 | 0.13 | 0.69 |
| Accumulative Dry | 226 | 207 | 274 | 11.6 | 0.06 |
| Matter Intake Feed | | | | | |
| supplement, lbs per | | | | | |
| calf 0 to 12 wk | | | | | |
| Feed to Gain | 1.57 | 1.63 | 2.09 | 0.09 | 0.06 |

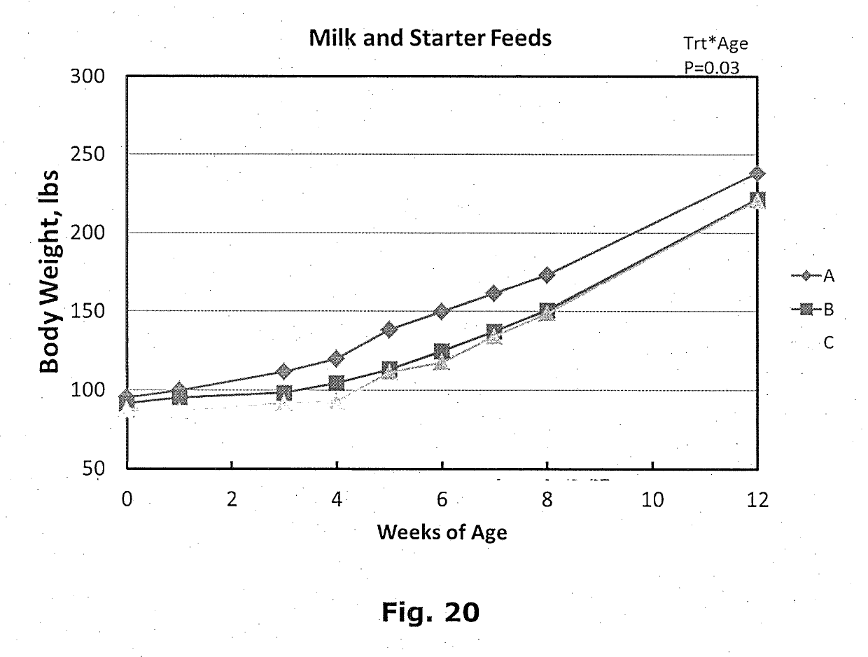

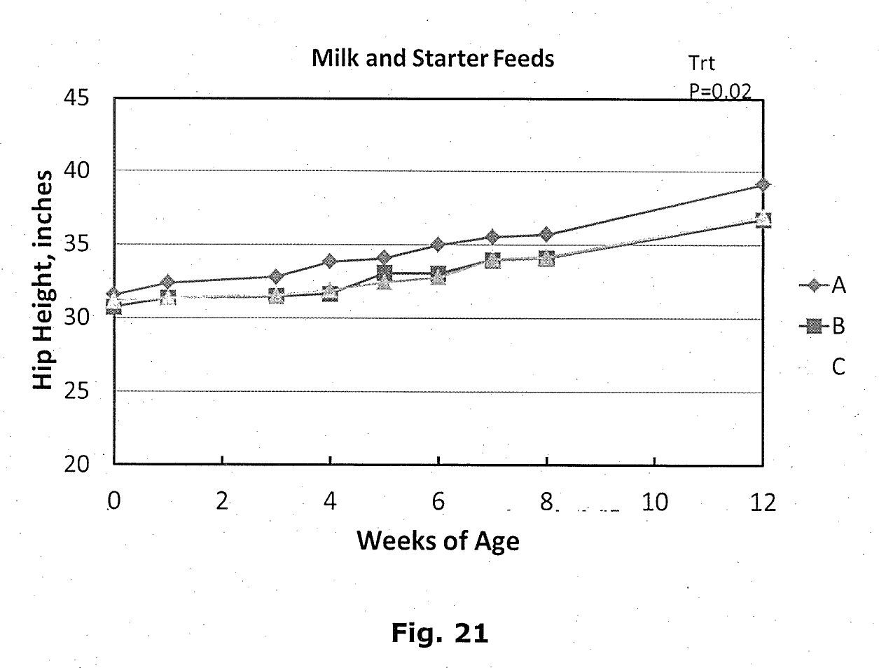

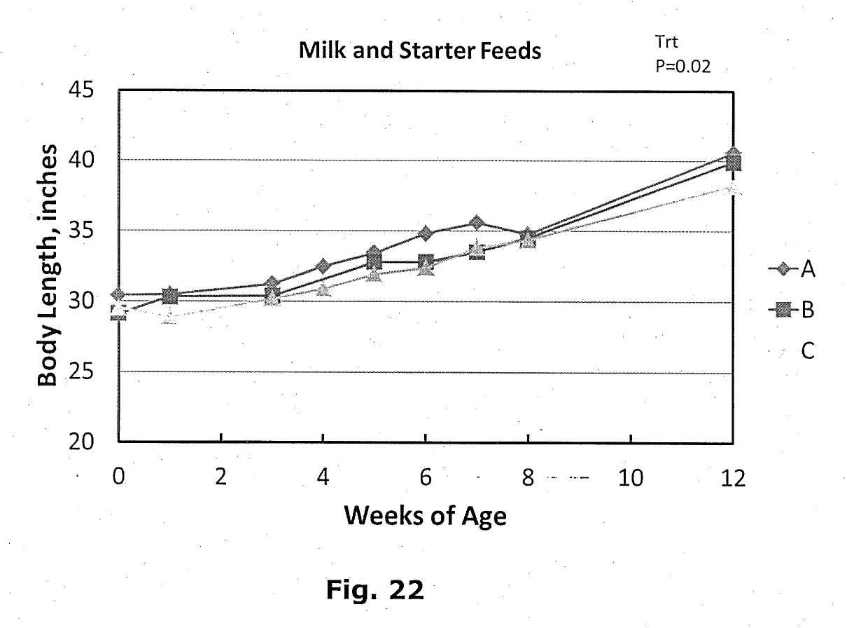

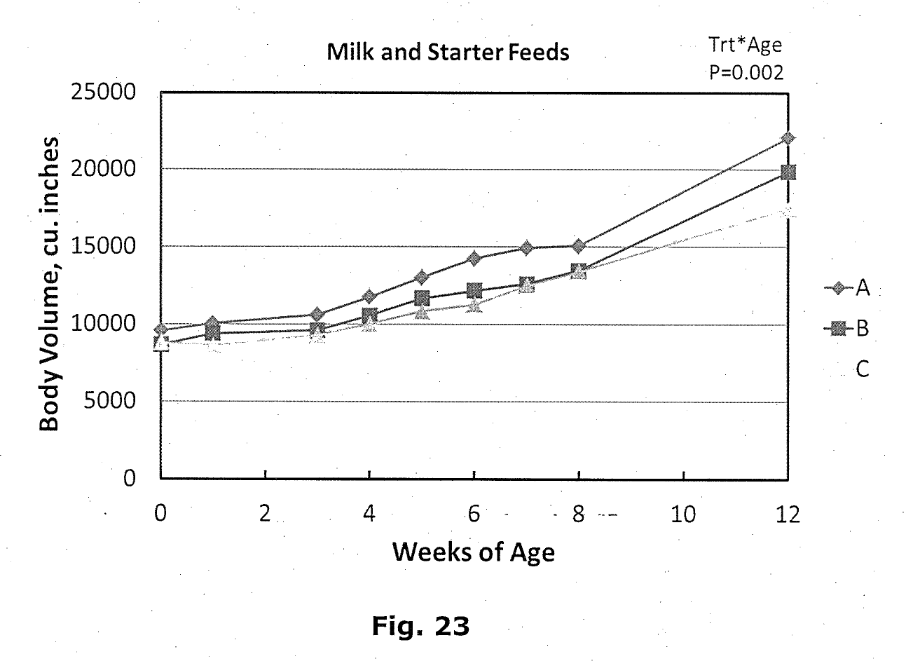

From Table 13A, growth generally improved for the HNP-treated calves compared to the MNP and LNP-treated calves. Although dry matter intake for the HNP and MNP treatment groups is lower for the twelve week period, much of the difference may be accounted for by increased intake of milk replacer and lower dry matter intake in these groups compared to the LNP group, up to week eight of age. Referring to FIGS. 20-23, these figures illustrate that the calves fed according to HNP and MNP treatments had a higher final body weight (FIG. 20), were taller (FIG. 21), longer (FIG. 22) and had an increased body volume (FIG. 23) compared to calves fed according to the LNP treatment. At the beginning stages of life, calves receiving the HNP and MNP treatments exhibited improved growth and more efficient intake of supplemental feed compared to calves receiving the LNP treatment. The HNP and MNP treatments provide for optimal growth of the calf and conditioning for rumen development. Further, studying a protein to fat ratio of a rib section, calves fed the HNP and MNP treatments, respectively, exhibited ratios of 3.2 and 2.6, which was a greater protein to fat ratio than calves in the LNP treatment having a ratio of 2.2. The protein to fat ratio study was conducted according to A. Y. Nour et al., Technical note: chemical composition of Angus and Holstein carcasses predicted from rib section composition, 72 J. Anim. Sci., 1239-1241 (1994).

Growing Ruminant Rumen Morphological Studies:

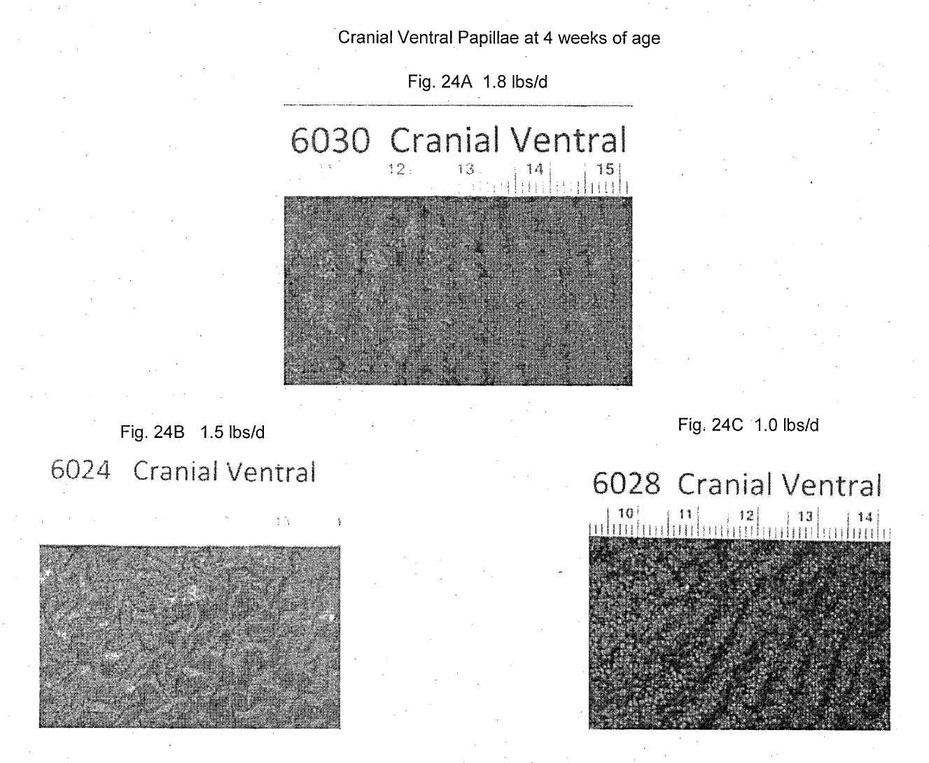

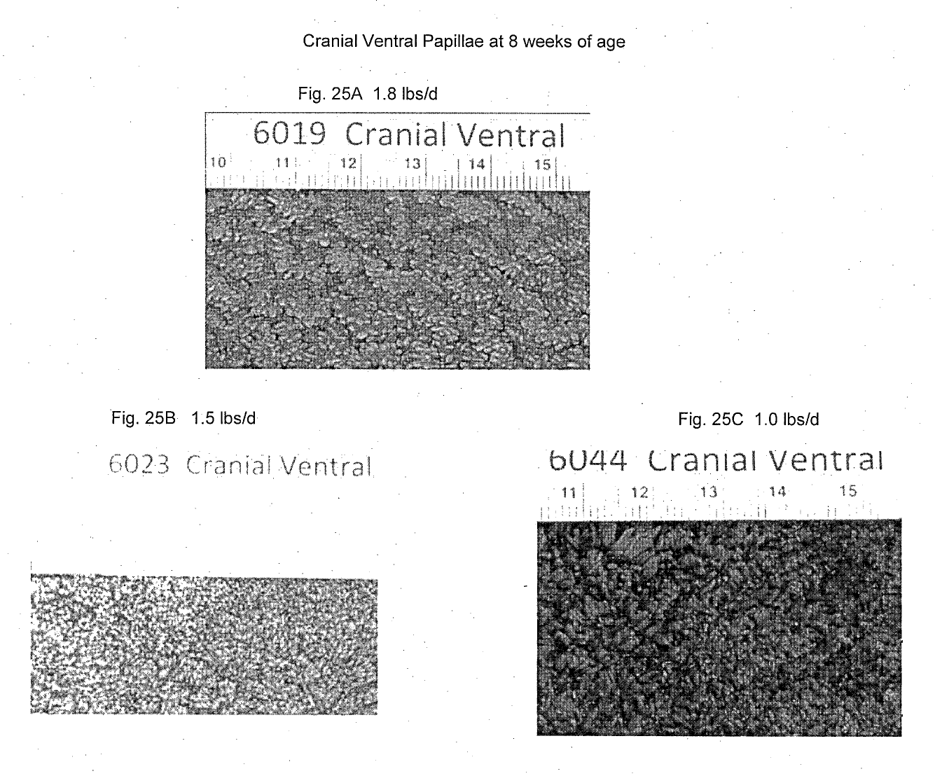

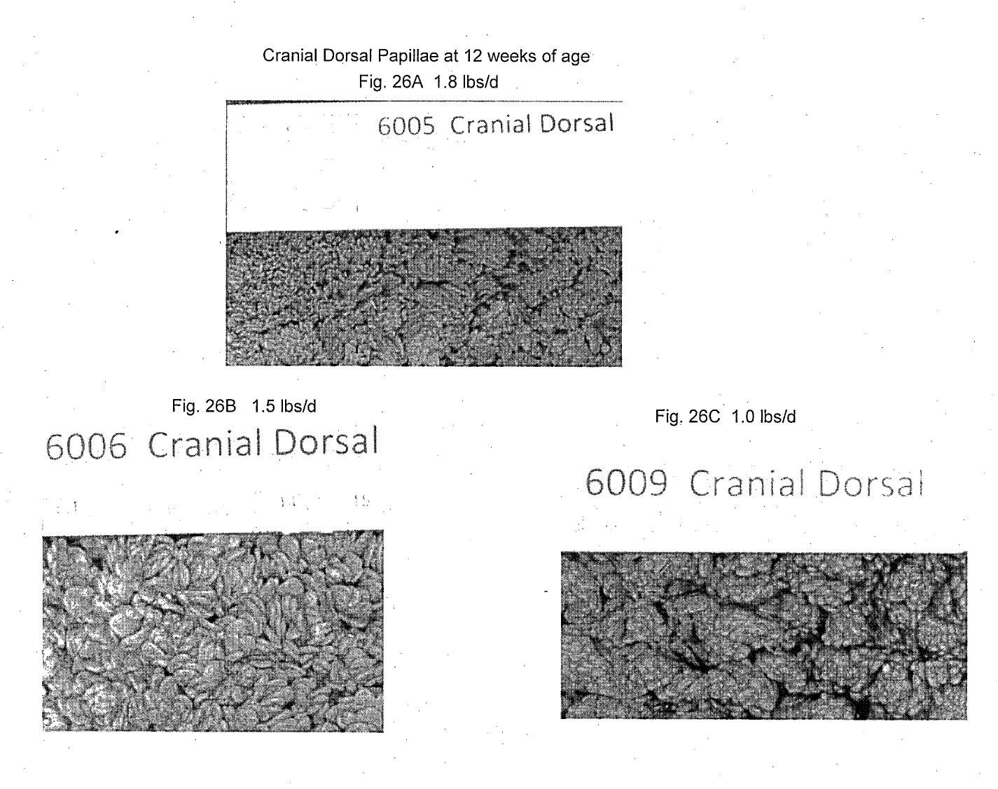

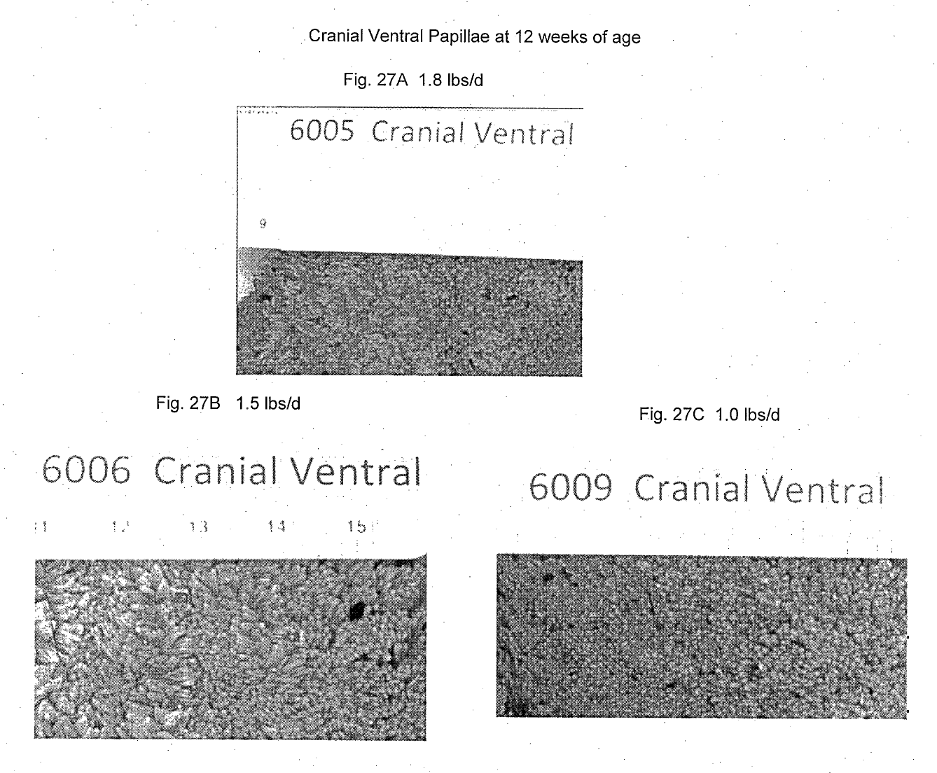

FIGS. 24A-24C, 25A-25C, 26A-26C, and 27A-27C illustrate ruminal papillae from sacrificial bull calves, where FIGS. 24A-24C, respectively, are cranial ventral ruminal papillae of calves at four weeks of age fed according to the HNP, MNP and LNP treatments. FIGS. 25A-25C, respectively, are cranial ventral ruminal papillae of calves at eight weeks of age fed according to the HNP, MNP and LNP treatments. FIGS. 26A-26C, respectively, are cranial dorsal ruminal papillae of calves at twelve weeks of age fed according to the HNP, MNP and LNP treatments. FIGS. 27A-27C, respectively, are cranial ventral ruminal papillae of calves at twelve weeks of age fed according to the HNP, MNP and LNP treatments.

Generally, upon ingesting dry feed, rumen papillae begin to develop. In conventional feeding programs, not enough nutrients are provided to the calf through milk replacer, so the calf tends to ingest dry feed to meet its needs. Once dry feed is ingested, the rumen papillae change, particularly with respect to color, and the study of Example 4, is used to determine when and how much dry feed should be ingested by the young ruminant during the first portion of the growing stage. With respect to FIGS. 24A-24C and 25A-25C, from about 4 to about 8 weeks of age, as the calf ingests dry feed, more fermentation takes place in the rumen, resulting in increased VFA and lower pH. This increased ruminal activity may result in initial stages of parakeratosis as shown by the dark coloration of the rumen in FIGS. 24C and 25C in which the LNP-treated calf ingested higher amounts of dry feed compared to the calves treated in the HNP (FIGS. 24A and 25A) and MNP (FIGS. 24B and 25B) groups.

With respect to FIGS. 26A-26C and 27A-27C, at twelve weeks of age, rumen and papillae size increase among all treatment groups. The papillae in FIGS. 26A and 26B in the cranial dorsal portion of the rumen appear healthy in size, surface area and coloration and may effectively absorb nutrients and may be conditioned for ingesting forage during the later portions of the growing period. However, the papillae in FIG. 26C are clumped together and show dark tissue coloration below, which means that a calf ingesting nutrients according to the LNP may have a loss of surface area of these papillae not able to effectively absorb nutrients, and thus impairing ability to utilize forages to supply nutrients. Therefore, the LNP treatment may not support proper rumen growth. In the cranial ventral portion of the rumen shown in FIGS. 27A-27C, papillae appear to be relatively healthy among the calves in the three treatment groups; however other calves fed according to the LNP treatment displayed darker coloration in the rumen, which can also be a sign of parakeratosis.

Studies of the differences in weight of the rumen and papillae tissue across groups show that whole tissue and papillae tissue weight of a defined sample of the rumen was not influenced by plane of nutrition, but that these weights were greater for calves at twelve weeks of age compared to the calves at four and eight weeks of age. At twelve weeks of age, muscle and sub-mucosal thickness of the rumen did not appear to be significantly modified by plane of nutrition. Further, as shown in Table 14, at twelve weeks of age, rumen papillae surface area and length was not significantly modified by plane of nutrition. This shows that growth performance was greater for calves fed higher planes of nutrition, and did not negatively impact rumen papillae or rumen wall development. Delivery of nutrients to support calf growth with greater portion of dry matter in the form of milk relative to dry feed starters did not negatively impact the rumen.

TABLE 14

| | Papillae gross measures at 12 Weeks of Age, | | | | |
|---|---|---|---|---|---|
| | after 12 weeks of feeding | | | | |
| | HNP | MNP | LNP | | Trt. Effect, |
| | Group | Group | Group | SE | P = |
| Papillae Surface | 11.63 | 7.67 | 9.04 | 1.560 | ns |
| Area, sq-mm | | | | | |
| Papillae Length, | 6.30 | 5.11 | 5.48 | 0.660 | ns |
| mm | | | | | |

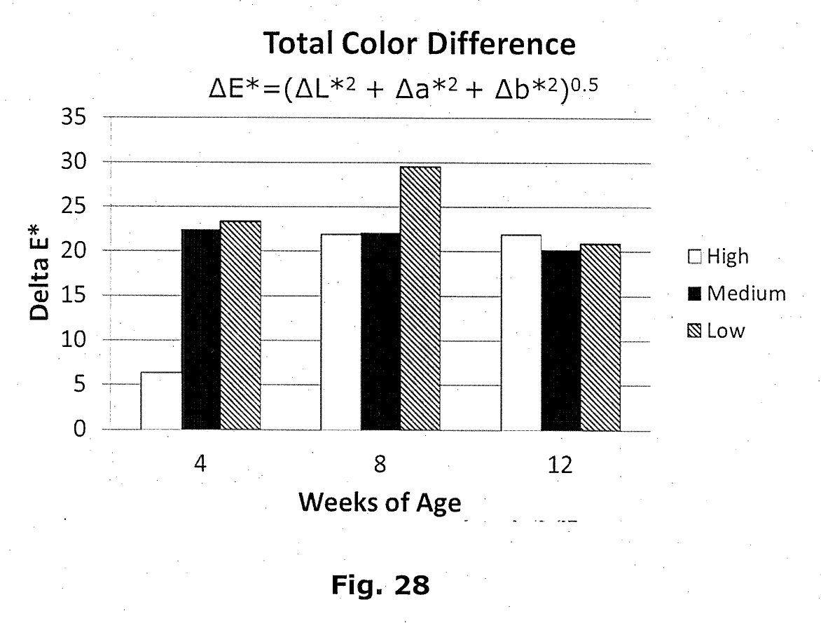

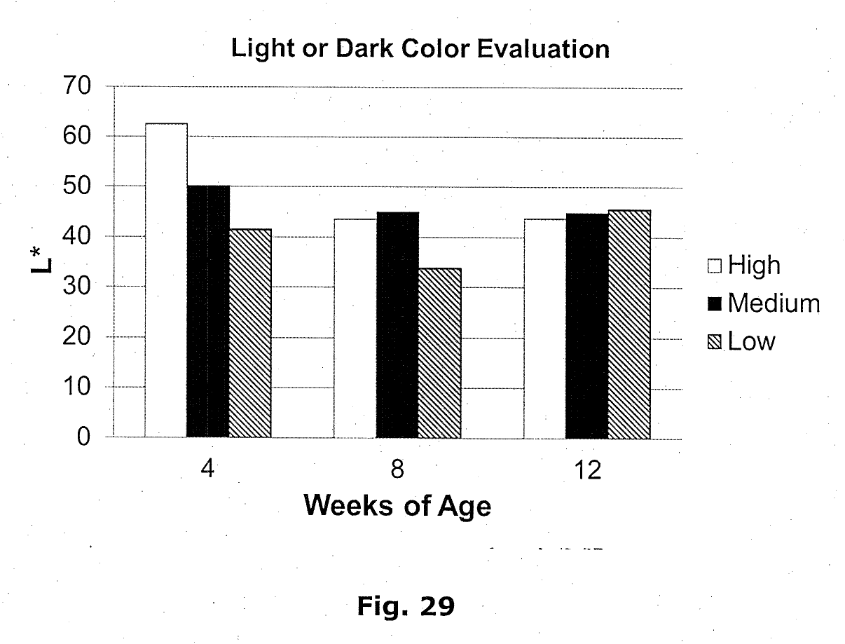

To further study rumen morphology, color reflected was determined with a Minolta CR-300 with 8 mm reading head, a chroma meter. Measurements of light or dark (white to black), red or green, and yellow or blue were taken using L, a, b color space techniques in duplicate of formalin fixed tissue strips. Rumens from calves consuming a greater portion of diet from milk in the HNP and MNP treatments were lighter in color compared to greater consumption of dry feeds at four weeks of age as shown from the total color difference ΔE*(where ΔE*=((ΔL*2)+(Δa*2)+(Δb*2))^{1/2}) in the chart of FIG. 28 and in the chart of FIG. 29 showing the light or dark color evaluation (*L, wavelength) across the three treatment groups at four, eight and twelve weeks of age, respectively. At twelve weeks of age, the tissues reflected color in a similar manner, as shown by the charts of FIGS. 28 and 29, indicating that plane of nutrition during early stages of life did not negatively impact the development of the rumen. Parakeratosis can lead to dark coloration of tissues. In the stratum corneum layer of the papillae, the keratin layer is infiltrated with nucleated cells. These rumens have the papillae that are enlarged, leathery, dark in color and often adhered to each other, thus reducing surface area of the papillae.

The HNP and MNP treatments provide improved growth while not negatively affecting rumen development, including papillae (e.g., surface area and histology). The calves fed according to the HNP and MNP implementations herein, upon reaching the end of the first portion of the growing period, are prepared for optimized rumen development during the second portion of the growing period.

Implementations herein provide optimized nutrient levels to the young calf through milk replacer and supplemental feed in the form of starter feed, which may be used alone or in combination with a feeding program in which a controlled, enhanced rate of supplemental dry feed is provided to the young calf with ad libitum access to forage so that the calf gradually increases consumption of forage over time. This is in contrast to prior approaches in which the calves have been provided and ingest very low nutrients from supplemental feeds and fed high levels of forage.

While the present disclosure provides rumen morphological data for sacrificial bull calves, those skilled in the art may appreciate that the study data from the bull calves is applicable to all ruminants, including heifers, and thus the feeding methods, feed formulation methods and feeding formulations are applicable to all growing ruminants. In addition, while the present disclosure provides examples of methods of feeding, methods of formulating feed, and feed formulations based on ruminant performance and rumen morphology in ruminants during the growing ruminant phase, or portion thereof, those skilled in the art may appreciate that the studies on ruminant performance and rumen morphology may be conducted at any stage in a ruminant's development and therefore the implementations may be applicable to ruminants at any developmental stage or across multiple developmental stages. For example, the ruminant's diet may be monitored and modified based on the methodologies provided herein until the ruminant grows to a mature weight of about 1200 to about 1400 pounds. Furthermore, the feeding formulations of the present disclosure may be provided to ruminants during one development stage and other feeding formulations may be provided at another development phase. For example, prior to providing the growing ruminant with the feed formulated according to the present disclosure, the calves may receive calf milk replacer until six weeks of age, as well as starter from day 3 to twelve weeks of age or another feed formulation for targeting frame and rumen growth from birth through six months of age, which may prepare the ruminant for high forage diets in later stages of development.

While the present disclosure provides various ranges, it will be understood that values, such as numeric integer values, at or within these ranges, or various ranges within the disclosed ranges, or ranges beginning or ending at a range value and beginning or ending at a value within the disclosed ranges may be used in particular embodiments without departing from the invention.

Although the present disclosure provides references to preferred embodiments, persons skilled in the art will recognize that changes may be made in form and detail without departing from the spirit and scope of the invention.

What is claimed is:

1. A method for improving rumen performance in growing ruminants based on rumen morphological studies, the method comprising orally administering to the growing ruminant a feed composition containing an effective amount of one or more of milk replacer and supplemental feed over a growing period of the growing ruminant to optimize rumen growth, wherein the feed composition is formulated based on the studies.

2. The method of claim 1, further comprising administering the feed composition formulated based on growing ruminant developmental studies to optimize rumen frame development.

3. The method of claim 1, wherein optimizing rumen growth comprises optimizing one or more of rumen size, rumen papillae density, rumen papillae surface area and rumen papillae histology.

4. The method of claim 1, wherein the effective amount of milk replacer is about 1.4 to about 2.5 pounds per day.

5. The method of claim 1, wherein the effective amount of supplemental feed is between about 8 pounds per day to about 12 pounds per day.

6. The method of claim 1, wherein orally administering the feed composition begins at about birth.

7. The method of claim 6, wherein orally administering the feed composition ends at about twenty-four weeks of age of the growing ruminant.

8. The method of claim 1, wherein the effective amount of grain in the supplemental feed is about 5 pounds per day to about 10 pounds per day.

9. The method of claim 1, wherein the feed composition further comprises ad libitum hay.

10. A method of formulating a feed formulation for a first ruminant comprising: studying rumen morphology of at least a second ruminant ingesting a first diet with an amount of one or more of calf milk replacer and supplemental feed; and
formulating the feed ration of one or more of calf milk replacer and supplemental feed for the first ruminant based on the rumen morphology studies of the second ruminant.

11. The method of claim 10, further comprising:
studying rumen morphology of at least a third ruminant ingesting a second diet with an amount of one or more of calf milk replacer and supplemental feed that is different from the amount of supplemental feed in the first diet; and
formulating the feed ration comprising the supplemental feed for the first ruminant based on the rumen morphology studies of the second and third ruminants.

12. The method of claim 11, wherein the rumen morphology studies for the second and third ruminant are conducted when the second and third ruminants are at approximately the same age.

13. The method of claim 11, wherein the second and third ruminants are fed the diets for a period of twelve weeks during a growing ruminant period.

14. The method of claim 10, wherein the feed ration comprises a growing heifer feed ration.

15. The method of claim 10, wherein studying the rumen morphology comprises studying one or more of rumen size, rumen papillae density, rumen papillae surface area and rumen papillae histology.

16. The method of claim 10, wherein formulating the feed ration comprises adjusting a feed ration.

17. A feed formulation for growing ruminants comprising an effective amount of at least one of milk replacer and supplemental feed to optimize rumen growth in the growing ruminants, the optimized rumen growth characterized by one or more of optimized rumen size, rumen papillae density, rumen papillae surface area and rumen papillae histology;
wherein the formulation is based on rumen morphological studies in growing ruminants.
